(19) United States
(12) Patent Application Publication
(10) Pub. No.: US 2023/0175088 A1
(43) Pub. Date: Jun. 8, 2023

(54) INTEGRATED SYSTEMS EMPLOYING CARBON OXIDE ELECTROLYSIS IN STEEL PRODUCTION

(71) Applicant: Twelve Benefit Corporation, Berkeley, CA (US)

(72) Inventors: Enrique Cintron, Brooklyn, NY (US); Nicholas H. Flanders, San Francisco, CA (US); Gregory DiCosola, Redmond, WA (US)

(21) Appl. No.: 18/062,459

(22) Filed: Dec. 6, 2022

Related U.S. Application Data
(60) Provisional application No. 63/265,090, filed on Dec. 7, 2021.

(51) Int. Cl. C21B 13/14; C25B 1/23; C25B 3/03; C25B 3/26; C25B 11/042; C25B 1/04; C21B 13/00; C21B 13/02

(52) U.S. Cl. CPC C21B 13/14; C25B 1/23; C25B 3/03; C25B 3/26; C25B 11/042; C25B 1/04; C21B 13/0073; C21B 13/023; C21B 2100/80

(57) ABSTRACT

Systems for producing iron may include (a) a reactor configured to receive iron ore and a reducing gas, and from these produce iron; and (b) a carbon dioxide reduction electrolyzer configured to produce at least carbon monoxide and/or a hydrocarbon. Such systems may be configured to transport carbon dioxide produced by the reactor and/or produced by combustion of a gas generated by the reactor to a cathode side of the carbon dioxide reduction electrolyzer. Such systems may be further configured to transport at least a portion of the carbon monoxide and/or hydrocarbon produced by the carbon dioxide reduction electrolyzer to the reactor, where the carbon monoxide and/or hydrocarbon serves as at least a part of the reducing gas.

### INCORPORATION BY REFERENCE

An Application Data Sheet is filed concurrently with this specification as part of the present application. Each application that the present application claims benefit of or priority to as identified in the concurrently filed Application Data Sheet is incorporated by reference herein in their entireties and for all purposes.

### FIELD

The present disclosure relates electrochemical cells for carbon dioxide reduction, which are integrated with metallurgy units.

### BACKGROUND

Electrolytic carbon dioxide reduction reactors have been proposed for capturing and converting waste carbon oxide to useful chemical products such as carbon monoxide and oxygen. Challenges remain for integrating such reactors into industrial operations that generate carbon dioxide. Such challenges include preparing carbon dioxide streams from disparate sources for electrolysis, controlling operation of electrolyzers to effectively use such carbon dioxide to produce appropriate chemical products, and incorporating one or more such chemical products into the material flows used by industrial operations that produce the carbon dioxide.

Background and contextual descriptions contained herein are provided solely for the purpose of generally presenting the context of the disclosure. Much of this disclosure presents work of the inventors, and simply because such work is described in the background section or presented as context elsewhere herein does not mean that such work is admitted prior art.

### SUMMARY

This summary is provided to introduce some concepts in simplified form that are further described below in the Detailed Description. This summary is not intended to identify key features or essential features of the claimed subject matter.

Some aspects of this disclosure pertain to systems for producing iron. Such systems may be characterized by the following features: (a) a direct reduction of iron ore (DRI) reactor configured to receive iron ore and a reducing gas, and from these produce iron; and (b) a carbon dioxide reduction electrolyzer configured to produce carbon monoxide and/or a hydrocarbon. Such systems may be configured to (i) transport carbon dioxide produced by the DRI reactor and/or produced by combustion of a gas generated by the DRI reactor to a cathode side of the carbon dioxide reduction electrolyzer and/or (ii) transport at least a portion of the carbon monoxide and/or hydrocarbon produced by the carbon dioxide reduction electrolyzer to the DRI reactor. The carbon monoxide and/or the hydrocarbon may serve as at least a part of the reducing gas. In certain embodiments, the carbon dioxide reduction electrolyzer comprises an anode containing a gold catalyst and during operation, such carbon dioxide reduction electrolyzer may produce carbon monoxide.

In some implementations, a system additionally includes a water electrolyzer configured to produce hydrogen from water. Such system may be further configured to transport at least a portion of the hydrogen produced by the water electrolyzer to the DRI reactor, wherein the hydrogen serves as at least a part of the reducing gas.

In some implementations, a system additionally includes a second carbon dioxide reduction electrolyzer, which second carbon dioxide reduction electrolyzer is configured to produce at least a hydrocarbon. In such implementations the other carbon dioxide reduction electrolyzer is configured to produce carbon monoxide Such system may be further configured to transport at least a portion of the hydrocarbon produced by the second carbon dioxide reduction electrolyzer to the DRI reactor, where the hydrocarbon serves as a source of carbon incorporated in the iron produced by the DRI reactor. In certain embodiments, the second carbon dioxide electrolyzer comprises an anode containing a transition metal catalyst. In certain embodiments, the hydrocarbon comprises methane and/or ethene. In certain embodiments, the DRI reactor is configured to produce the iron having a carbon concentration of at least about 2% carbon by weight.

In some embodiments, the DRI reactor is further configured to generate a top gas fuel. In such embodiments, a system may be further configured to combust the top gas fuel and provide carbon dioxide produced by combustion of the top gas fuel to the cathode side of the carbon dioxide reduction electrolyzer.

In some embodiments, the system is configured receive external carbon dioxide from a source external to the system and provide said external carbon dioxide to the cathode side of the carbon dioxide reduction electrolyzer.

In some embodiments, the system is configured to (i) transport the carbon dioxide produced by the DRI reactor and/or produced by the combustion of a gas generated by the DRI reactor to the cathode side of the carbon dioxide reduction electrolyzer; and (ii) transport at least a portion of the carbon monoxide and/or the hydrocarbon produced by the carbon dioxide reduction electrolyzer to the DRI reactor.

In some embodiments, the system additionally includes a hydrocarbon reformer configured to produce at least a portion of the reducing gas from an external source of hydrocarbon and the carbon dioxide produced by the DRI reactor and/or produced by combustion of a gas generated by the DRI reactor. In certain embodiments, the system does not include a hydrocarbon reformer.

In some embodiments, the system further comprises one or more post processing units configured to physically and/or chemically modify the iron produced by the DRI reactor. In such embodiments, the system may be configured to transport carbon dioxide produced by the one or more post processing units to the cathode side of the carbon dioxide reduction electrolyzer.

Some aspects of this disclosure pertain to methods for producing iron. Such methods may be characterized by the following operations: (a) providing iron ore and a reducing gas to a direct reduction of iron ore (DRI) reactor configured to receive the iron ore and the reducing gas, and produce iron; (b) electrochemically reducing, by a carbon dioxide reduction electrolyzer, carbon dioxide to produce carbon monoxide and/or a hydrocarbon; and (c) transporting at least a portion of the carbon monoxide and/or the hydrocarbon produced by the carbon dioxide reduction electrolyzer to the DRI reactor and/or transporting the carbon dioxide, which is produced by the DRI reactor and/or produced by combustion of a gas generated by the DRI reactor, to a cathode side of the carbon dioxide reduction electrolyzer. In some embodiments, the carbon dioxide reduction electrolyzer comprises an anode containing a gold catalyst.

In certain embodiments, a method additionally includes operations of: (e) electrochemically reducing water, by a water electrolyzer, to produce hydrogen from the water; and (f) transporting at least a portion of the hydrogen produced by the water electrolyzer to the DRI reactor, wherein the hydrogen serves as at least a part of the reducing gas.

In certain embodiments, a method additionally includes operations of: (e) electrochemically reducing, by a second carbon dioxide reduction electrolyzer, at least a portion of the carbon dioxide to produce at least a hydrocarbon; and (f) transporting at least a portion of the hydrocarbon produced by the second carbon dioxide reduction electrolyzer to the DRI reactor, wherein the hydrocarbon serves as a source of carbon incorporated in the iron produced by the DRI reactor. In such embodiments, the other carbon dioxide reduction electrolyzer may produce carbon monoxide. In some implementations, the second carbon dioxide electrolyzer comprises an anode containing a transition metal catalyst. In some implementations, the DRI reactor produces the iron with a carbon concentration of at least about 2% carbon by weight. In some implementations, the hydrocarbon comprises methane and/or ethene.

In certain embodiments, a method additionally includes operations of: (e) generating a top gas fuel at the DRI reactor; (f) combusting the top gas fuel; and (g) providing carbon dioxide produced by combustion of the top gas fuel to the cathode side of the carbon dioxide reduction electrolyzer.

In certain embodiments, a method additionally includes operations of: (e) receiving external carbon dioxide from a source external to the system; and (f) providing said external carbon dioxide to the cathode side of the carbon dioxide reduction electrolyzer.

In certain embodiments, (c) comprises transporting at least a portion of the carbon monoxide and/or the hydrocarbon produced by the carbon dioxide reduction electrolyzer to the DRI reactor, and transporting the carbon dioxide, which is produced by the DRI reactor and/or produced by combustion of a gas generated by the DRI reactor, to the cathode side of the carbon dioxide reduction electrolyzer.

In certain embodiments, the method further comprises reforming hydrocarbon from an external source with the carbon dioxide produced by the DRI reactor and/or produced by combustion of a gas generated by the DRI reactor to produce at least a portion of the reducing gas. In certain embodiments, the method does not include reforming a hydrocarbon.

In certain embodiments, the method further comprises physically and/or chemically modifying the iron produced by the DRI reactor, and transporting carbon dioxide, produced during physically and/or chemically modifying the iron, to the cathode side of the carbon dioxide reduction electrolyzer.

Some aspects of this disclosure pertain to systems that may be characterized by the following elements: (a) a blast furnace configured to receive iron ore, coke, and to produce iron; and (b) a carbon dioxide reduction electrolyzer configured to produce carbon monoxide and/or a hydrocarbon. Such systems may be configured to (i) transport carbon dioxide produced by the blast furnace and/or produced by combustion of a gas generated by the blast furnace to a cathode side of the carbon dioxide reduction electrolyzer; and/or (ii) transport at least a portion of the carbon monoxide and/or the hydrocarbon produced by the carbon dioxide reduction electrolyzer to the blast furnace.

In certain embodiments, the systems further comprise a coke oven configured to produce the coke and a coke oven gas, and wherein the system is configured to transport at least carbon dioxide from the coke oven gas to carbon dioxide reduction electrolyzer.

In certain embodiments, the blast furnace is configured to produce blast furnace gas. In such systems, the system may be configured to transport at least carbon dioxide from the blast furnace gas to carbon dioxide reduction electrolyzer.

In certain embodiments, the systems are configured to both (i) transport carbon dioxide produced by the blast furnace and/or produced by combustion of the gas generated by the blast furnace to the cathode side of the carbon dioxide reduction electrolyzer; and (ii) transport at least the portion of the carbon monoxide and/or the hydrocarbon produced by the carbon dioxide reduction electrolyzer to the blast furnace.

Other aspects of this disclosure pertain to methods that may be characterized by the following operation: (a) providing iron ore, coke, and a reducing gas to a blast furnace, which produces iron from the iron ore, the coke, and the reducing gas; (b) electrochemically reducing, by a carbon dioxide reduction electrolyzer, carbon dioxide to produce carbon monoxide and/or a hydrocarbon; and (c) transporting at least a portion of the carbon monoxide and/or the hydrocarbon produced by the carbon dioxide reduction electrolyzer to the blast furnace, and/or transporting the carbon dioxide, which is produced by the blast furnace and/or produced by combustion of a gas generated by the DRI reactor, to a cathode side of the carbon dioxide reduction electrolyzer.

In some embodiments, the methods further comprise producing the coke and a coke oven gas from a coke oven; and transporting at least carbon dioxide from the coke oven gas to carbon dioxide reduction electrolyzer.

In some embodiments, the methods further comprise: (i) producing blast furnace gas from the blast furnace; and (ii) transporting at least carbon dioxide from the blast furnace gas to carbon dioxide reduction electrolyzer.

In some embodiments, (c) comprises (i) transporting at least a portion of the carbon monoxide and/or the hydrocarbon produced by the carbon dioxide reduction electrolyzer to the blast furnace, and (ii) transporting the carbon dioxide, which is produced by the blast furnace and/or produced by combustion of a gas generated by the blast furnace, to the cathode side of the carbon dioxide reduction electrolyzer.

In the above-described aspects of the disclosure, any combination of the one or more dependent features may be implemented together with, or apart from, one another when used with the primary system or method aspect. Additional aspects and features of the disclosure will be presented below, sometimes with reference to associated drawings.

### BRIEF DESCRIPTION OF THE DRAWINGS

FIG. 1A represents a conventional steel making system employing a blast furnace.

FIG. 1B represents the steel making system of FIG. 1A but identifies access points for integration of a carbon dioxide electrolyzer.

FIG. 1C illustrates a steelmaking system employing a carbon dioxide electrolyzer and a blast furnace. Flue gas generated from the combustion of blast furnace gas, coke oven gas, coal, and/or natural gas being collected and sent to a carbon capture unit and provided to the electrolyzer.

FIG. 2A illustrates one example of a conventional DRI system which may be modified to include a carbon dioxide electrolyzer.

FIG. 2B represents the steel making system of FIG. 2A but identifies access points for integration of a carbon dioxide electrolyzer.

FIG. 2C illustrates a DRI steelmaking system employing a carbon dioxide electrolyzer to enhance a reformer-based direct iron reduction unit.

FIG. 2D illustrates a DRI steelmaking system employing a direct reduction process where a CO+H₂ syngas is created by electrolyzer and a carburizing gas is also created by an electrolyzer.

FIG. 3 illustrates a steelmaking system employing a carbon dioxide electrolyzer used in conjunction with an electric arc furnace and/or one or more other downstream steel processing operations.

FIG. 4 depicts an example system for a carbon oxide reduction reactor that may include a cell comprising a MEA (membrane electrode assembly).

FIG. 5 depicts an example MEA for use in COₓ reduction. The MEA has a cathode layer and an anode layer separated by an ion-conducting polymer layer.

### DETAILED DESCRIPTION

### Terminology

Unless defined otherwise, all technical and scientific terms used herein have the same meaning as commonly understood by one of ordinary skill in the art. The terms presented immediately below may be more fully understood by reference to the remainder of the specification. The following descriptions are presented to provide context and an introduction to the complex concepts described herein. These descriptions are not intended to limit the full scope of the disclosure.

An “electrochemical cell” comprises an anode, a cathode, and electrolyte between the anode and cathode. At least one of the anode and cathode can undergo, catalyze, or otherwise support a faradaic reaction. In an electrolytic electrochemical cell, an external circuit applies an electrical potential difference between the anode and cathode, and that potential difference drives the faradaic reaction(s). Examples include electrolyzers such as CO₂ electrolyzers and water electrolyzers. It also includes some forms of CO₂ purifiers, particularly those that employ faradaic reactions at an anode and/or a cathode.

Carbon oxide—As used herein, the term carbon oxide includes carbon dioxide (CO₂), carbon monoxide (CO), carbonate ions (CO₃²), bicarbonate ions (HCO₃⁻), and any combinations thereof. Carbonate and bicarbonate ions may be viewed as ions that “carry” or “hold” CO₂ in form that can be dissolved, melted, or otherwise provided in a liquid form, at least temporarily.

A mixture contains two or more components and unless otherwise stated may contain components other than the identified components.

As used herein, the term “about” is understood to account for minor increases and/or decreases beyond a recited value, which changes do not significantly impact the desired function the parameter beyond the recited value(s). In some cases, “about” encompasses +/−10% of any recited value. As used herein, this term modifies any recited value, range of values, or endpoints of one or more ranges.

As used herein, the terms “top,” “bottom,” “upper,” “lower,” “above,” and “below” are used to provide a relative relationship between structures. The use of these terms does not indicate or require that a particular structure must be located at a particular location in the apparatus.

### Introduction and Context

Carbon oxide electrolyzers containing polymer-based membrane electrode assemblies (MEAs) are designed or configured to produce oxygen from water at an anode and produce one or more carbon-based compounds through the electrochemical reduction of carbon dioxide or other carbon oxide at a cathode. Various examples of MEAs and MEA-based carbon oxide electrolyzers are described in the following references: Published PCT Application No. 2017/192788, published Nov. 9, 2017, and titled “REACTOR WITH ADVANCED ARCHITECTURE FOR THE ELECTROCHEMICAL REACTION OF CO₂, CO, AND OTHER CHEMICAL COMPOUNDS,” Published PCT Application No. 2019/144135, published Jul. 25, 2019, and titled “SYSTEM AND METHOD FOR CARBON DIOXIDE REACTOR CONTROL,” and Published PCT Application No. 2021/108446, published Jun. 3, 2021, and titled “MEMBRANE ELECTRODE ASSEMBLY FOR COX REDUCTION,” each of which is incorporated herein by reference in its entirety. Carbon oxide electrolyzers may be integrated into any of various industrial systems. The integration may involve producing any of various chemical products that can be used for downstream processing. Examples of such products include carbon monoxide, methane, ethene, hydrogen, oxygen, and any combination thereof. Downstream processing may produce intermediate products for production of valuable industrial products such as polymers, liquid hydrocarbons, fuels, and the like. Various examples of carbon oxide electrolyzers operating conditions and such electrolyzers integrated in industrial operations are described in the following references: PCT Application Publication No. 2019/144135, published Jul. 25, 2019, and titled “SYSTEM AND METHOD FOR CARBON DIOXIDE REACTOR CONTROL” and PCT Application No. PCT Application Publication No. 2022/031726, published Feb. 10, 2022, and titled “SYSTEM AND METHOD FOR CARBON DIOXIDE REACTOR CONTROL,” each of which is incorporated herein by reference in its entirety and for all purposes.

Today, the steel sector accounts for roughly 7% of CO₂ emissions worldwide. In order to be on track to meet reductions targets, overall CO₂ emissions need to fall about 50% by 2050 and reach neutrality by 2070.

While new technologies are under development to decrease total carbon dioxide emissions, they cannot fully eliminate them. Carbon is a fundamental part of steel chemistry, and as such carbon will continue to have an important role in the making of steel, whether added upstream in the reduction process or downstream during melting, some of this carbon will be lost as emission.

Currently, carbon sequestration remains a challenge for many steel sites. While carbon can be captured, sequestration can prove daunting as many steel plants are not necessarily located near geological formations to contain the carbon.

A carbon dioxide electrolyzer may be configured for integration with an industrial operation such as steelmaking. An electrolyzer so integrated may be configured, designed, and/or controlled in a manner that allows the electrolyzer to produce one or more carbon oxide electrolysis products in a quantity, concentration, and/or ratio suitable for integration with a steelmaking operation. Carbon dioxide electrolyzers may be integrated with any of various steelmaking systems or subsystems such as iron ore reduction reactors, steel production reactors, and steel post-processing units. Additionally, or alternatively, carbon oxide electrolyzers may be integrated with other units associated with steelmaking such as chemical separation units, purification units, and the like, optionally along with associated sensing and/or control systems. Integrated steelmaking systems may employ one or more carbon oxide electrolyzers disposed upstream, downstream, and/or in parallel with the one or more steelmaking systems or subsystems.

Systems and methods for carbon dioxide reactor control may focus on maximization of aspects relating to production of carbon monoxide (CO) and/or other carbon-containing products (CCPs) (e.g., methane or ethene), such as maximizing ratios of CO to other reactor products (e.g., CO:H₂ ratio), CO concentration, and/or total CO output or output rate.

However, for some applications, simply maximizing aspect values can be undesirable, and that arbitrary control of such aspects (e.g., dynamic or selective aspect control to meet a value within a range of target aspect values), rather than simple maximization, can be beneficial. For example, it can be desirable to selectively control the CO:H₂ ratio of the reactor products (e.g., enabling arbitrary control within a spectrum from the highest CO:H₂ ratio possible for a given system and/or process, down to approximately 1:3 CO:H₂ or lower). With such control, the reactor output can be effectively used (e.g., where the reactor outputs are directly fed to a subsequent input) for applications such as steelmaking.

A carbon oxide electrolyzer may obtain carbon oxides from various sources. As mentioned, examples of carbon oxide reactants include carbon dioxide, carbon monoxide, carbonate, and/or bicarbonate. In certain embodiments, a carbonate or bicarbonate is provided in the form of an aqueous solution (e.g., an aqueous solution of potassium bicarbonate) that can be delivered to the cathode of a reduction cell. Carbonates and bicarbonates may be obtained from various sources (e.g., minerals) and/or by various reactions (e.g., reacting carbon dioxide with hydroxide).

A system may optionally include an upstream source of carbon dioxide connected to an input of a carbon dioxide electrolyzer of the disclosure. In some embodiments, the source of carbon dioxide is output of a combustion reaction, a natural gas processing system, a blast furnace, a coke oven, a direct reduction of iron ore reactor, a steel post-processing module, a basic oxygen furnace, a methane reformer, a system performing Boudouard reactions, a direct air capture (DAC) of carbon dioxide systema Fischer Tropsch reactor, and the like. Many of these carbon dioxide sources may exist in a steel manufacturing facility. Examples include a steel blast furnace system, capable of producing blast furnace gas, a coke gas production system, a direct reduction of iron ore system, a basic oxygen furnace for producing steel, an electric arc furnace for producing steel; and steel postprocessing systems for processes such as rolling, alloy addition, etc.

An upstream source of carbon dioxide from steelmaking may be connected directly to an input of a carbon dioxide electrolyzer (e.g., serves as the input, such as connected to the reduction catalyst via the cathode flow field and/or gas diffusion layer, etc.) or alternatively the upstream source may be connected to a purification system; a gas compression system; or both a purification system and a gas compression system, in either order; which then connect to an input of a carbon dioxide system of the disclosure. Multiple purification and/or gas compression systems (e.g., scrubbers, etc.) may be employed.

Various types of carbon dioxide purifier may be employed to purify carbon dioxide prior to its use in a carbon dioxide electrolyzer. One type of purifier is a sorbent-based purifier such as used in conventional scrubbers and in DAC systems that employ “swing” processes such as temperature swing and humidity swing processes to alternately capture carbon dioxide from an input stream and release purified carbon dioxide. A further discussion of some examples of sorbent-based carbon dioxide purifiers is contained in US Patent Application Publication 202201136119, published May 5, 2022, and titled “SYSTEM AND METHOD FOR CARBON DIOXIDE REACTOR CONTROL,” which is incorporated herein by reference in its entirety. Other types of carbon dioxide purifiers employ membranes that selectively pass or block passage of carbon dioxide. Other types of carbon dioxide purifiers include electrochemical or electrodialysis systems. Some of these contain polymers or other organic compounds containing carbon dioxide capture moieties that form bonds with carbon dioxide in a first electrical state and release carbon dioxide in a second electrical state. For example, quinone moieties may capture and release carbon dioxide when subject to cathodic and anodic conditions. Electrodialysis systems employ membranes that selectively pass or block certain ions such as ions that can transport carbon dioxide (e.g., carbonate and bicarbonate ions).

The carbon dioxide, carbon monoxide, or carbonate provided as input to a carbon oxide electrolyzer integrated with a steelmaking operation may, depending on the construction and operating conditions of the electrolyzer, have a range of concentrations. In certain embodiments, carbon dioxide provided to a carbon dioxide reduction reactor has a concentration of at least about 20 mole percent, or at least about 40 mole percent, or at least about 75 mole percent, or at least about 90 mole percent. In certain embodiments, carbon dioxide provided to a carbon dioxide reduction reactor has a concentration of about 40 to 60 mole percent.

An upstream source of water for a carbon oxide electrolyzer integrated with a steelmaking operation may come from any of various source and in various forms such as purified tap water, purified sea water, a byproduct of direct air capture of water, optionally with capture of carbon dioxide, combustion processes that may also produce carbon dioxide feedstock, fuel cell byproduct, and the like.

A steelmaking operation may include components for capturing, conveying, and/or utilizing one or more outputs of a carbon oxide electrolyzer in a downstream system. A carbon oxide reactor output of the disclosure may be directly connected (e.g., via the cathode flow field and/or gas diffusion layer) to a downstream system, and/or the carbon dioxide reactor output may be connected to a purification system; a gas compression system; or both a purification system and a gas compression system, in either order; which then optionally connect to an input of a downstream system. Multiple purification systems and/or gas compression systems may be employed.

A downstream steelmaking system may produce carbon dioxide output in addition to other product outputs. A system may further include a connection between a carbon dioxide containing output of a downstream system and an input of a carbon dioxide electrolyzer. The carbon dioxide containing output of a downstream system may be directly connected to an input of a carbon dioxide reactor or alternatively the downstream carbon dioxide containing output may be connected to a purification system; a gas compression system; or both a purification system and a gas compression system, in either order; which then connect to an input of a carbon dioxide reactor of the disclosure. Multiple purification systems and/or gas compression systems may be employed.

A carbon dioxide electrolyzer can make a range of products (for example, methane, ethene, carbon monoxide (CO), molecular hydrogen (H₂), ethane, and oxygen) that can be used in downstream systems and processes. Different carbon dioxide reactors (e.g., including different layer stacks, catalysts and/or catalyst layers, PEMs, flow fields, gas diffusion layers, cell compression configurations, and/or any other suitable aspects, etc.) can be used to achieve different reduction products; however, different reduction products can additionally or alternatively be achieved by adjusting the operation parameters, and/or be otherwise achieved.

An integrated system comprising a steel making unit and a carbon dioxide electrolyzer may be configured to convert the direct products of the electrolyzer to a valuable final product such as a liquid fuel, a polymer (e.g., a polycarbonate or a polyurethane), an oxalate, a formate, bulk chemical such as a glycol, phosgene, etc.

In some embodiments, the integrated system is configured such that direct or indirect products of the carbon dioxide electrolyzer are utilized by a steel making unit. For example, carbon monoxide produced by the electrolyzer may be provided to a direct reduction of iron ore reactor and facilitate reduction of iron ore. In such cases, the carbon monoxide may be combined with hydrogen from another source such as a water electrolyzer. In another example, carbon monoxide and/or a hydrocarbon produced by the carbon dioxide electrolyzer is combusted (alone or in combination with some other gas produced in steel making) to provide energy for a different process such as methane reforming and/or one or more downstream steel processing operations. In another example, a hydrocarbon such as ethene or methane produced by the carbon dioxide electrolyzer is provided to a carburization portion of a direct reduction of iron ore reactor to add carbon in the steel produced by the reactor.

Some integrated systems have a carbon dioxide reactor that both consumes carbon dioxide produced by a steel making unit and provides a carbon dioxide reduction product (e.g., CO, CH₄, C₂H₄) to the steel making unit and/or another unit associated with steel making. In this way, the carbon is recycled in a steel making facility and carbon dioxide emissions are reduced. Various examples of such integrated steel making systems are presented herein.

A system may further include a source of electrical energy connected to a carbon oxide electrolyzer. The source of electrical energy may include a solar electrical energy production system, a wind electrical energy production system, a geothermal electrical energy production system, a fossil fuel electrical energy production system, a nuclear power plant, a hydroelectric system, or any other system capable of electrical energy production. Any such system may be used alone or in combination to produce electrical energy to power operation of the one or more electrolyzers used in steelmaking.

A system may be employed to store electrical energy in the form of chemical energy. For example, power producers may produce excess power during off-peak usage periods. Systems containing carbon oxide reduction reactors are able to respond quickly to a need to consume excess power. They do not need to warm up to operate, and they can be cycled between power on and power off states without deterioration of carbon dioxide reactors. The ability to respond quickly to power utilization needs allows systems to work well with intermittent sources of power such as solar electrical energy production systems, and wind electrical energy production systems.

Each of the features described above in this section, and any combination of these features, may be included in the embodiments disclosed below, including in the embodiments depicted in the figures, which sometimes simply focus on the key modules and connection paths of integrated systems. Those of skill in the art will ready appreciate how the features described above may be integrated in any of the systems and methods described elsewhere herein.

### Blast Furnace Embodiments

Carbon dioxide emissions from blast furnace steelmaking originate from process and heating requirements of the different unit operations. Coke ovens and blast furnaces themselves generate significant quantities of off gas containing byproducts of the ironmaking and coking process, mainly N₂, CO, CO₂, and H₂. Aptly called coke oven gas (COG) and blast furnace gas (BFG), these gases contain combustible compounds, so they are often burned as a low energy fuel onsite before release into the atmosphere. Downstream, other activities such as steel rolling and heat treatment generate emissions through the burning of natural gas and other fossil fuels. All together, these activities generate about 2 tons of carbon dioxide for every ton of blast furnace steel produced.

One possible way to reduce such carbon dioxide emissions is to sequester some or all of the carbon dioxide. However, n conventional carbon capture and sequestration (CCS) schemes, captured CO₂ is delivered by pipeline or vehicle to a site suitable for long term sequestration. This constrains capture and sequestration to plants in regions that have both the infrastructure present to transport the CO₂ and the geological requirements to sequester long term. Capital in terms of pipelines and sequestration facilities must be developed to process these CO₂ streams leading directly to costs of sequestration. Further, sequestration has yet to be commercially proven at scale.

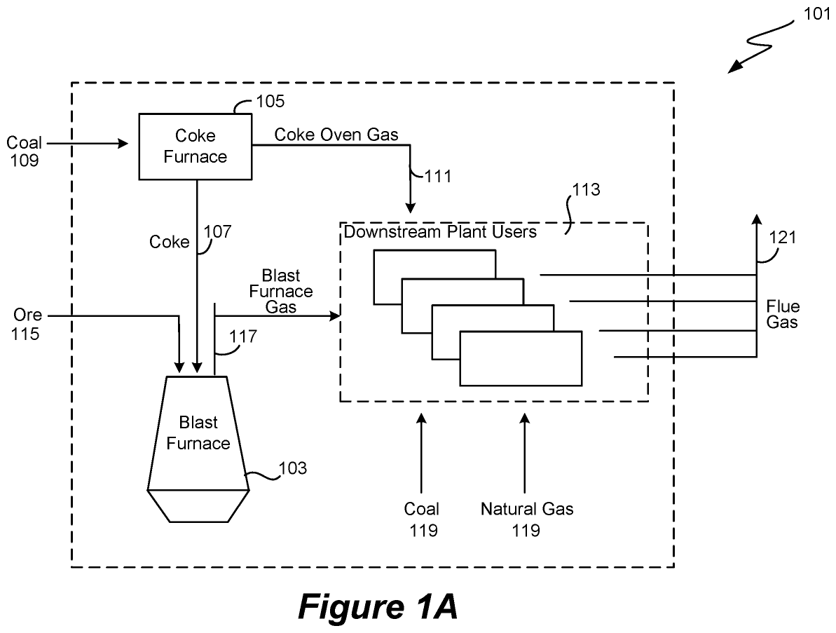

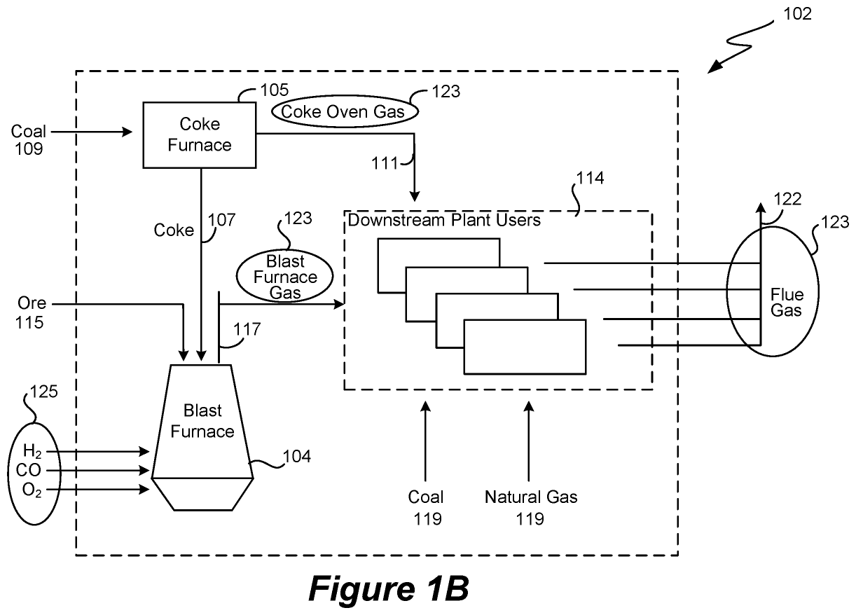

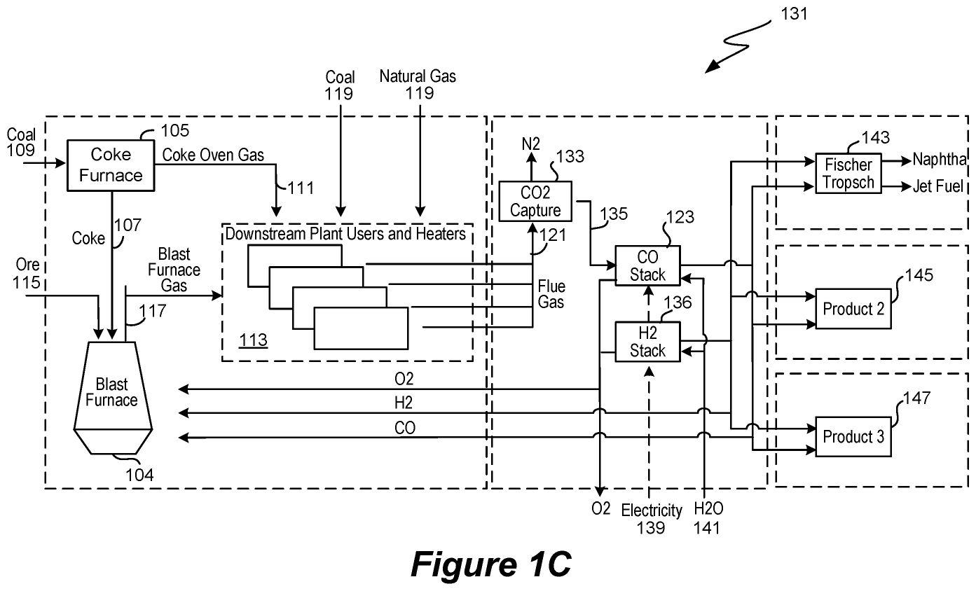

FIG. 1A illustrates some components in a conventional steel making system 101 employing a blast furnace 103. As illustrated, system 101 employs blast furnace 103, a coke oven 105, and one or more downstream subsystems 113 that may be used in the steel making process. In operation, coke oven 105 produces coke 107 from coal 109. Coke oven 105 also produces coke oven gas 111.

Inputs to blast furnace 103 include coke 107 and iron ore 115. The reaction in the blast furnace may produce pig iron or a related product. Pig iron typically contains about 3 to 5% carbon by weight. This is too much carbon for most commercial uses, so the pig iron may be further processed by, e.g., a basic oxygen furnace or an electric arc furnace to reduce the carbon content. Such furnaces may be among the downstream subsystems 113.

During operation, blast furnace 103 produces blast furnace gas 117, which may be used in one or more of the downstream subsystems 113. For example, blast furnace gas 117 may be combusted to produce heat used in such processes. During operation, a byproduct of the coke oven is coke oven gas 111, which may be used in one or more of the downstream subsystems. For example, coke oven gas 111 may be combusted, optionally along with blast furnace gas 117 to produce heat used in such processes.

Downstream subsystems may require additional fuel to provide heat for their processes. In some cases, coal and/or natural gas 119 serves as the additional fuel. The combustion and/or other oxidation reactions associated with processes in the downstream subsystems 113 produces flue gas 121.

In certain embodiments, electrolyzer technology creates usable products and feedstock from the CO₂ using electricity and in some cases water. Examples of such embodiments are illustrated in FIGS. 1B and 1C. In some cases, flue gas generated from the combustion of Blast Furnace Gas, Coke Oven Gas, coal, and natural gas is collected and sent to a carbon capture unit. The carbon capture unit can be one of any existing capture technology, but not limited to pressure swing adsorption, membrane separation, and cryogenic separation. The captured CO₂ is directed to a CO₂ electrolyzer. Within the electrolyzer, the CO₂ is converted on-site into chemical feedstocks where some may be used internally within the steel facility (e.g., oxygen) and others may be used externally for other purposes such as feedstocks for other industries.

In some implementations, an electrolysis cell is configured to produce a mixture of CO and H₂ (syngas), and release a byproduct of oxygen, all of which can be recycled back into steel production. In some implementations, an electrolysis cell is configured to produce methane, ethene and higher hydrocarbons which additionally or alternatively may be used in steel production. These molecules (CO, H₂, CH₄, and/or O₂) can also be transformed into valuable commodity products such as sustainable aviation fuel or feeds for the polymer industry, either way valorizing the CO₂ and reducing or eliminating emissions from steel production.

In some embodiments, oxygen from a CO₂ electrolyzer supplies a blast furnace and/or a basic oxygen furnace. Note that for a coal-based blast furnace, the output iron may go to a separate furnace (a basic oxygen furnace not shown in the figure) where oxygen is added to remove the excess carbon. In some embodiments, syngas produced by a CO₂ electrolyzer is used to wholly or partially offset coal requirements through injection into the blast furnace, improving performance further.

FIG. 1B illustrates a steel making system 102, similar to conventional steel making system 101, but employing one or more carbon dioxide electrolyzers configured to consume carbon dioxide produced by steel making operations and/or produce gas that may be employed in the steel making.

As illustrated, system 102 employs a coke oven 105 as in system 101, and a blast furnace 104 and one or more downstream subsystems 114 that may be identical to or modified versions of blast furnace 103 and downstream subsystems 113 of system 101. Each of components 105, 104, and 114 operates essentially as their counterparts in system 101 operate by, e.g., generating coke oven gas 111, blast furnace gas 117, and flue gas 122. Notably, however, one or more carbon dioxide electrolyzers 123 may be integrated into system 102 to consume carbon dioxide present in coke oven gas 111, blast furnace gas 117, and/or flue gas 122. Optionally, system 102 includes one or more gas separation units, compressors, heat exchangers, etc. to process gas 111, gas 117, and/or gas 122 to render it/them in a form suitable for input to carbon dioxide electrolyzer(s) 123.

In some embodiments, system 102 includes one or more electrolyzers 125 that produce one or more input gases that supplement coke 107 as a source of heat and/or carbon for the reaction in blast furnace 104. As illustrated, such input gases may include hydrogen, carbon monoxide, oxygen, or some combination thereof. Electrolyzer(s) 125 may be a carbon dioxide electrolyzer optionally along with a water electrolyzer. If electrolyzer 125 uses carbon dioxide from coke oven gas 111, blast furnace gas 117, flue gas 122, or any combination thereof, some carbon in the process is recycled, rather than being emitted to the environment. In some cases, one or more electrolyzers 125 comprise one or more of the carbon dioxide electrolyzer(s) 123.

FIG. 1C illustrates an integrated steel making system 131 having a blast furnace 104, a coke oven 105, and one or more downstream subsystems 113, similar to corresponding components in systems 101 and 102. Like system 102, system 131 includes a carbon dioxide electrolyzer configured to consume some or all the carbon dioxide contained in flue gas 121 from subsystems 113. Carbon dioxide electrolyzer 123 is configured to produce carbon monoxide, and system 131 is configured to deliver such carbon monoxide to blast furnace 104.

System 131 include a carbon dioxide capture unit 133 configured to receive flue gas 121 as an input and then separate carbon dioxide from other components such as nitrogen. In some embodiments, unit 133 comprises a sorbent for carbon dioxide and operates to capture and release the carbon dioxide by a temperature swing, a humidity swing, a pressure swing, or oscillating process. Unit 133 produces a purified carbon dioxide output stream 136 that is optionally pressurized for delivery to carbon dioxide electrolyzer 123, where it is electrochemically reduced to produce, e.g., carbon monoxide.

System 131 includes a water electrolyzer 135 that is configured to receive water and electrochemically produce molecular hydrogen and molecular oxygen. Carbon dioxide electrolyzer 123 and water electrolyzer 135 may share resources and/or infrastructure such as electricity 139 and water 141. During operation, carbon monoxide produced by carbon dioxide electrolyzer 123 and hydrogen produced by water electrolyzer 135, optionally along with some oxygen produced by either or both electrolyzers, is provided to blast furnace 104. Further, system 131 may be configured to provide carbon monoxide and/or hydrogen produced by electrolyzer 123 and/or electrolyzer 125 to one or more downstream process for producing materials that may be unrelated to steel. For example, hydrogen and carbon monoxide may be provided to a Fischer Tropsch reactor 143, which is configured to produce naphtha and/or jet fuel. Optionally, a second downstream reactor 145 is configured to receive electrolyzer-produced carbon monoxide and/or hydrogen and produce a second product. And optionally, a third downstream reactor 147 is configured to receive electrolyzer-produced carbon monoxide and/or hydrogen and produce a third product.

### DRI Embodiments

CO₂ emissions from producing Direct Reduced Iron (DRI) originate from the use of natural gas to perform the reduction of iron. The Midrex NG Process and the Energiron ZR Process are two commercial processes in use today. In these processes, natural gas is reformed into a synthesis gas containing CO and H₂ either in-situ within a shaft furnace or in a separate reformer. That synthesis gas is then used to reduce iron oxide to iron as it travels down a shaft furnace. Iron reduced in this fashion generates on the order of 1 ton of CO₂ for every ton of steel produced.

In a typical implementation, iron ore is introduced into the top of a shaft furnace, CO and H₂ are introduced lower in the furnace to the reduction zone, and iron in the form of sponge iron or a related iron-containing material leaves the bottom of the shaft furnace.

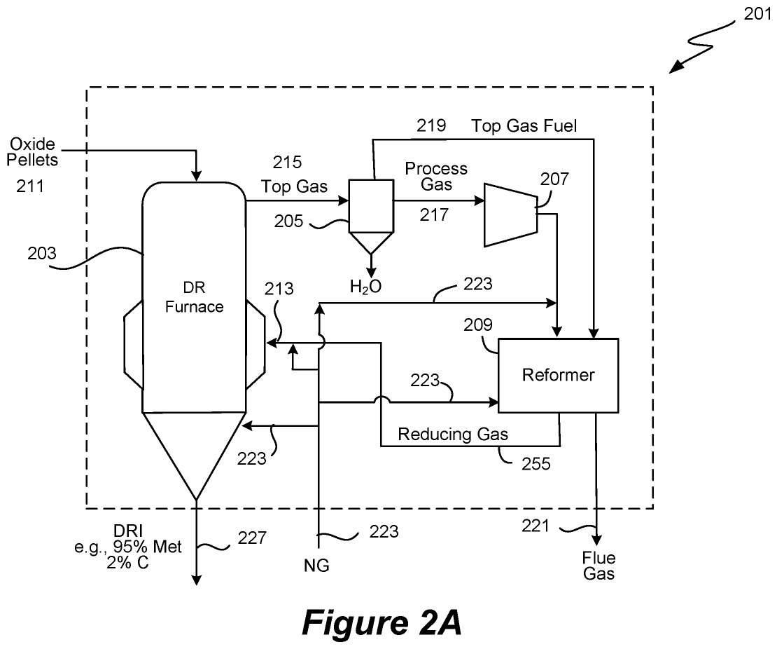

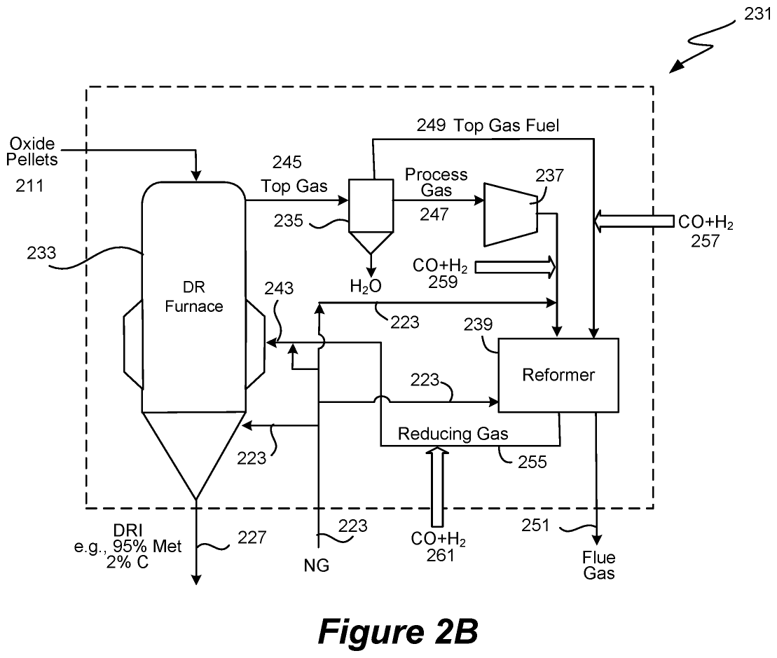

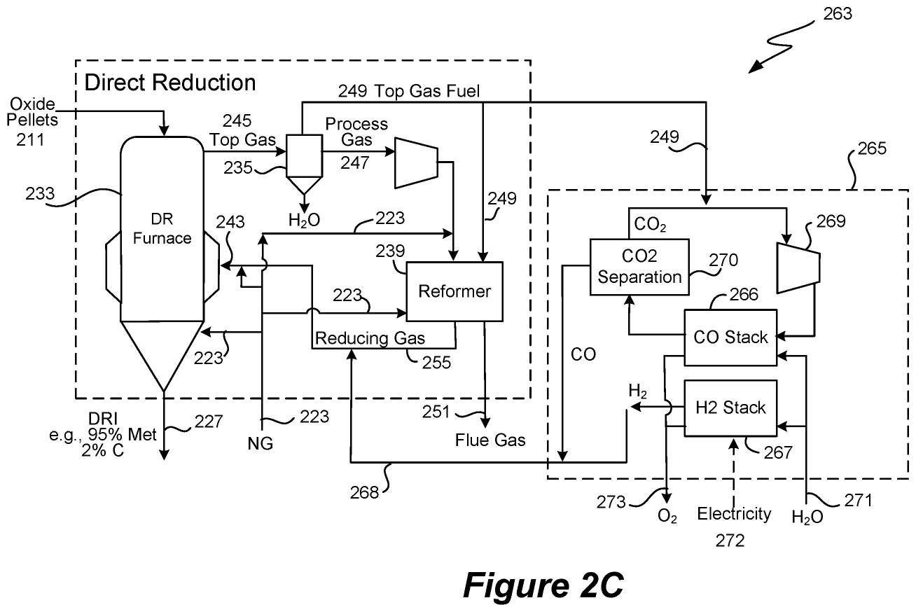

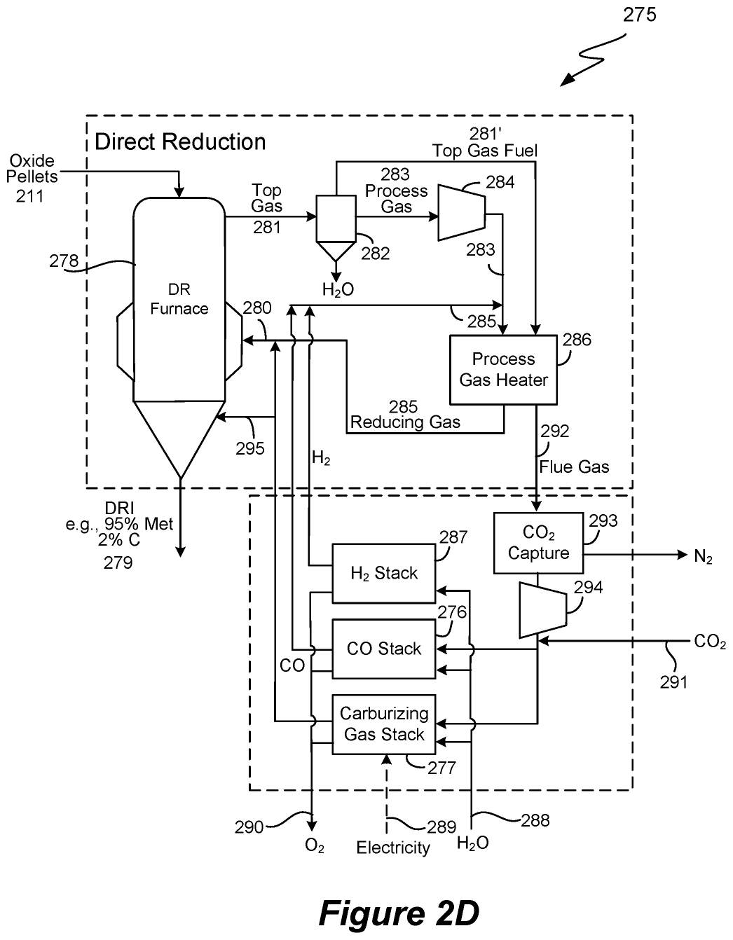

FIG. 2A depicts an example of a conventional DRI system 201, which may be modified as disclosed herein to include a carbon dioxide electrolyzer. As illustrated conventional system 201 includes a DR furnace 203, a scrubber 205, a compressor 207, and a reformer 209. In some implementations, a DR furnace is configured to receive iron oxide at the top of the reduction furnace where it flows down and reacts counter-currently with reducing gas, sometimes referred to as bustle gas, injected into a reduction zone. Concurrently, natural gas is injected to a transition zone (also referred to as a carburization zone) to carburize the DRI before removal from the furnace as sponge iron or related iron-containing material. In the example of system 201, DR furnace 203 is configured to receive iron oxide 211 at the top of the furnace, reducing gas 213 at a reduction zone of the furnace, and carburizing gas 223 (which may be natural gas or other carbon-bearing gas such as carbon monoxide or ethene) at a transition zone of the furnace. The reduction zone reduces the iron oxide to elemental iron, and the transition zone adds some carbon to the iron. In operation, DR furnace 203 produces a metal product 227, which may be sponge iron.

During the ore reduction process, DR furnace 203 generates high temperature (typically above 300° C.) top gas 215, which contains carbon dioxide and some fuel components such as methane and carbon monoxide. Top gas 215 leaves the top of the reduction furnace 203. System 201 is configured to deliver top gas 215 to top gas scrubber 205, which may be implemented as a venturi and/or a water scrubber. During operation, top gas scrubber 205 may quench the top gas 215 to cool the gas and remove dust and other particulate fines. This condenses excess water which may be directed to a clarifier.

The remaining gas may be divided into two streams, which are labeled as process gas 217 and top gas fuel 219 in system 201. In some embodiments, both streams have the same composition. However, top gas fuel 219, which may be a minority of the gas exiting scrubber 205, is used to meet some of the heat needs of reformer 209, while process gas 217 is recompressed in the process gas compressor 207.

In the depicted embodiment, a reformer 209, which may be a dry methane reformer, is configured to receive both streams 217 and 219. It may combust the top gas fuel stream 219 to provide heat to drive the methane reforming reaction. During combustion, the top gas fuel is converted to flue gas 221. In some embodiments, system 201 includes a heat recovery unit (not shown) configured to recover some heat from flue gas 221.

Compressor 207 is configured to pressurize process gas 217 before the gas is provided to reformer 209, which operates at elevated pressures and temperatures. A heat source, such as a unit configured to recover heat from flue gas 221, may preheat process gas 217 to the reformer inlet temperature.

Reformer 209 is configured to receive carbon dioxide and methane—reactants of the dry reforming reaction—via a pure natural gas stream 223 and via a mixture of natural gas stream 223 and process gas 217. In reformer 209, these reactants produce hydrogen and carbon monoxide, which exit reformer 209 as reducing gas 225.

System 201 is configured to deliver reducing gas 225 to the reducing section of DR furnace 203. System 201 may be configured to combine some carburizing gas from stream 223 with reducing gas 225 before these gases enter the reducing section of furnace 203 as reducing gas 213. System 201 is also configured to deliver carburizing gas 223 to the transition zone of DR furnace 203.

The DRI process generates a low heating value top gas fuel. This gas contains CO₂ and uncondensed water formed when reducing iron as well as the unreacted H₂, CO, and CH₄. Within the DRI process, this top gas fuel may be burned to offset the burner side natural gas used for providing heat to the methane reformer. As in the blast furnace example, CO₂ present in the flue gas post-combustion can be captured and used as a feedstock for a CO₂ electrolyzer.

However, because the DRI process is syngas based, the syngas produced from a CO₂ electrolyzer can be utilized directly in the DRI furnace to affect iron reduction. Syngas produced from the electrolyzer may be heated and directed to the reduction furnace. CO₂ formed by the reduction may be captured and recycled within the electrolysis unit. In this process, would-be CO₂ emissions from the DRI process may be recaptured and recycled as CO to the DRI furnace and only leave as solid carbon present on the DRI. In fact, under certain conditions, the process may be operated carbon dioxide negative, meaning that it consumes more CO₂ than it generates.

While one benefit of this electrolzyer-enhanced DRI system is to create a DRI product containing carbon without the associated emissions of the conventional process, its practice also alleviates potential challenges in finding product markets that are of sufficient size to absorb all the carbon dioxide emitted for steel production. Steel is one of the largest commodities produced, and the supply of CO₂ can easily outstrip the demand for many high value chemical products. Having a means to recycle carbon within the process can decrease the dependence on matching the scale of downstream products with level of emissions from the steel industry today.

Conventional electrolysis technologies employed in direct reduction have been limited solely to the production of hydrogen gas as a means of partially or fully replacing natural gas used, and thereby CO₂ emitted, for direct reduction. There are many challenges introduced when replacing natural gas with hydrogen at high levels. For example, maintaining a sufficiently high temperature to reduce iron oxides within the reduction zone is harder as conditions in hydrogen reduction are much more endothermic as compared to reducing gas composed of both hydrogen and CO. Additionally, a lower fraction of CO and CH₄ in the reducing gas diminishes the amount of carbon present on the product DRI. Further, thermodynamic equilibrium for hydrogen is less favorable than the equilibrium for carbon monoxide in the upper furnace. Still further, compression of hydrogen in centrifugal compressors is more challenging as its low molecular rate requires higher tip speeds or more stages to reach the similar compression ratios.

To maintain a minimal level of carbon, natural gas is added to the transition zone, but the overall carbon efficiency remains low due to the high partial pressure of hydrogen throughout the reduction zone. The transition zone is a section of the shaft furnace where reducing gas is introduced. It is located below a reduction zone (where iron ore is chemically reduced). Larger compressors can be used to achieve higher gas flows to provide enough heat to reduce the iron within the shaft furnace. For pre-existing facilities, this can limit their ability to utilize hydrogen to decrease CO₂ emissions without substantial capital modifications.

Certain embodiments disclosed herein provide alternative processes that utilize one or more carbon dioxide electrolyzers to produce a syngas comprising CO, and optionally H₂ and/or light hydrocarbons in the direct reduction of iron ore. The one or more carbon dioxide electrolyzers may also be used to provide oxygen that can be used to enhance combustion efficiency in a methane reformer.

FIG. 2B illustrates various optional modifications to a conventional DRI system such as system 201. The modifications take the form of one or more CO₂ electrolyzers integrated with the conventional DRI system 201. As illustrated, an integrated system 231 includes a DR furnace 233, a scrubber 235, a compressor 237, and a methane reformer 239, similar or identical to components 203, 205, 207, and 209, respectively, in system 201. However, system 231 may include one or more carbon dioxide electrolyzers that introduce carbon monoxide or syngas into the system at various points. Systems of this disclosure may be any of the depicted electrolyzers along or in any combination with the others. In some embodiments, one carbon dioxide electrolyzer may provide carbon monoxide or syngas at two or more points in system 231.

As depicted, in some embodiments, system 231 includes an electrolyzer 257 configured to provide carbon monoxide and optionally some hydrogen to a top gas fuel stream 249. During steel making, DR furnace 233 generates top gas 245, which is fed to top gas scrubber 235, which, in turn, separates water and particles from the top gas 245 and releases process gas 247 and top gas fuel 249. During operation, top gas fuel 249 is delivered to reformer 239 where it is combusted to provide heat energy for the reforming reaction. Carbon monoxide and optionally hydrogen produced by electrolyzer 257 is added to the top gas fuel 249 to supplement the fuel to reformer 239.

In some embodiments, electrolyzer 257 is configured to produce a product other than carbon monoxide and hydrogen. For example, electrolyzer 257 may be configured to produce a hydrocarbon such as methane, ethene, ethane, or any combination thereof. Such hydrocarbon may be used as fuel to heat reformer 239.

As depicted, in some embodiments, system 231 includes an electrolyzer 259 configured to provide carbon monoxide and optionally some hydrogen to a compressed process gas stream 247. In such embodiments, reactant gas to reformer 239 includes the process gas 247, the carbon monoxide from electrolyzer 259, and carburizing gas (which may be natural gas) from a stream 223. As illustrated, carburizing gas 223 may enter reformer 239 unmixed (lower path) or mixed with process gas, optionally including carbon monoxide from electrolyzer 259. Reformer 239 produces reducing gas 255 that, during operation, is supplied to the reducing section of DR furnace 233. As illustrated reducing gas 255 may be mixed with carburizing gas 223 to form a mixed gas stream 243 that enters the reducing section of furnace 233. As mentioned, electrolyzer 259 may be configured to produce a product other than carbon monoxide and hydrogen. Such hydrocarbon may be used as a reactant in reformer 239.

As depicted, in some embodiments, system 231 includes an electrolyzer 261 configured to provide carbon monoxide and optionally some hydrogen to reducing gas stream 255. In such embodiments, the carbon monoxide, hydrogen, and/or other reducing gases produced by reformer 239 are supplemented by reduction products of carbon dioxide electrolyzer 261. Hence the amount of carburizing or natural gas required by system 231 for use in reformer 239 is reduced. One or more carbon dioxide electrolyzers may be configured to produce a reducing gas in a ratio sufficient complement any carburizing gas provided to a DR furnace. A measure for the reduction zone in a DR furnace is to have gas quality Q>9 where Q=(H2+CO)/(H2O+CO₂). As an example, a H2/CO ratio may be 0.5 to 3.0 but this is set by the fuel source. For NG the H2/CO ratio is typically 1.6

While not depicted in the figure, any of electrolyzers 257, 259, and 261 may be configured to receive carbon dioxide from flue gas 251, top gas 245 (or 249), or other gas stream. In these cases, the electrolyzer(s) may be operated in a manner that converts the received carbon dioxide to carbon monoxide and optionally hydrogen for introduction to one of the noted gas streams in system 231. This recycles some carbon in system 231 and thereby reduces carbon emissions in the steel making process.

FIG. 2C illustrates an integrated DRI steel making system 263 employing an electrolyzer subsystem 265 comprising a carbon dioxide electrolyzer 266 and a water electrolyzer 267. Electrolyzer 266 and/or electrolyzer 267 may be implemented as stacks of electrolyzer cells.

System 263 is configured to deliver carbon dioxide via a portion of top gas fuel stream 249 to a cathode side of electrolyzer 266. System 263 is also figured to transport a reduction product of carbon dioxide electrolyzer 266 (typically carbon monoxide) to the reduction zone of DR furnace 233 as part of a reducing gas 243. In operation, carbon monoxide produced by carbon dioxide electrolyzer 266 is mixed with hydrogen produced by water electrolyzer 267 to produce a syngas stream 268 that is then mixed with the reducing gas 255 output from reformer 239 that is provided as the input gas stream 243 to the reduction zone of DR furnace 233.

As indicated, carbon dioxide electrolyzer 266 may receive carbon dioxide from top gas fuel stream 249. In the depicted embodiment, system 263 includes a carbon dioxide separator 270 (e.g., a sorbent or membrane-based separator) configured to receive gas output by the cathode side of electrolyzer 266 and separate carbon dioxide from other components of the gas output such as carbon monoxide and, in some cases, hydrogen. System 263 is configured to recycle the carbon dioxide from separator 270 to electrolyzer 266. However, in the depicted embodiment, the recycled carbon dioxide is mixed with top gas fuel 249 to provide a mixture that is fed to a compressor 269 configured to compress the mixed gas to a pressure suitable for carbon dioxide electrolyzer 266. In alternative embodiments (not shown), at least a portion of the carbon dioxide input to electrolyzer 266 derives from flue gas 251. In other embodiments, carbon dioxide separator 270 receives top gas fuel 249 as an input and provides purified carbon dioxide to a compressor, which then provides the pressurized and purified carbon dioxide to electrolyzer 266.

Water electrolyzer 267 is configured to receive water as an input and provide hydrogen and oxygen streams as outputs. Electrolyzers 266 and 267 may share resources and/or infrastructure. In the depicted embodiment, a water stream 271 and an electrical source 272 supply both electrolyzers. Further, the anodes of both electrolyzers produce oxygen. Hence the anode output streams of both electrolyzers may be combined to form an oxygen output stream 273.

As illustrated in FIGS. 2A-2C, systems employing DR furnaces may employ a methane reformer to produce the reducing gas used by the furnace. Such reformers may employ a process known as dry reforming (also sometimes called carbon dioxide reforming) to produce syngas from a reaction of carbon dioxide with hydrocarbons such as methane in the presence of a metal catalyst (e.g., Ni or a Ni alloy). Thus, two greenhouse gases are consumed and useful chemical building blocks, hydrogen and carbon monoxide, are produced. Some DRI making systems do not include a reformer. In some such cases, the systems employ a carbon dioxide electrolyzer configured to produce a hydrocarbon such methane, ethene, or ethane that can be provided to a carburizing zone of a DR furnace. Such systems may optionally operate without a source of natural gas.

Now referring to the diagram in FIG. 2D, another DRI-electrolyzer system 275 is depicted. In this system, a direct reduction process is implemented using a CO+H₂ syngas created by a first carbon dioxide electrolyzer 276, optionally together with a water electrolyzer 287, and using a carburizing gas created by a second carbon dioxide electrolyzer 277.

A direct reduction furnace 278 is used to create a DRI product 279 containing carbon. Iron oxide 211 is introduced at the top of reduction furnace 278 where it flows down and reacts counter-currently with a syngas based reducing gas 280, sometimes referred to as bustle gas, injected into a reduction zone of furnace 278. A carburizing gas 295 created in carbon dioxide electrolyzer 277 composed of, e.g., a combination of CH₄, ethene, and optionally other light hydrocarbons is injected to a transition zone of furnace 278 to carburize the DRI before removal from the furnace.

During steel making operations, an effluent top gas 281 leaves the top of reduction furnace 278 and is quenched in a top gas scrubber 282 (e.g., a water scrubber) to cool the gas and remove dust and other particulate fines. This condenses excess water which may be directed to a clarifier. The output of top gas scrubber 282 is a process gas 283 and top gas fuel 281′. After cleaning, the resulting process gas 283 is sent to a process gas compressor 284 that compresses the process gas. Optionally, system 275 includes a carbon dioxide removal unit (not shown), which may optionally be a membrane-based unit, to improve the reducing properties of process gas 283. In some implementations, the carbon dioxide removal unit is disposed upstream of compressor 284.

System 275 is configured to mix pressurized process gas 283 with carbon monoxide produced by electrolyzer 276 and hydrogen produced by water electrolyzer 287 to produce a reducing gas 285 and then provide that reducing gas to a heater 286, which may produce heat by combusting top gas fuel 281′. During steel making, heated reducing gas 285 may be combined with a hydrocarbon such as methane and/or ethene produced by second carbon dioxide electrolyzer 277. The resulting mixture serves as the reducing gas 280 that is fed to the reduction zone of DR furnace 278.

Electrolyzers 276, 277, and 287 may share resources and/or infrastructure. In the depicted embodiment, a water stream 288 and an electrical source 289 may supply all three electrolyzers. Further, the anodes of all three electrolyzers produce oxygen. Hence the anode output streams of the electrolyzers may be combined to form an oxygen output stream 290.

In some embodiments, oxygen from the first carbon dioxide electrolyzer 276, the second carbon dioxide electrolyzer 277, and/or the water electrolyzer 287 is used in combustion within process gas heater 286 to raise the temperature of reducing gas 285. In some embodiments, oxygen from stream 290 is provided to heater 286.

System 275 is configured to provide carbon dioxide to first carbon dioxide electrolyzer 276 and second carbon dioxide electrolyzer 277. The input carbon dioxide may come from an external source 291 and/or from flue gas 292 of process gas heater 286. In the depicted embodiment, system 275 includes a carbon dioxide capture or purification unit 293, which is configured to receive the flue gas 292 and purify carbon dioxide in the flue gas by, e.g., removing nitrogen and/or other non-CO₂ gases. System 275 also includes a compressor 294 configured to receive purified CO₂ and increase its pressure before delivery to the cathode sides of carbon dioxide electrolyzers 276 and 277. In certain embodiments, carbon dioxide capture unit 293 is a sorbent-based unit (e.g., a temperature or humidity swing system) or a membrane-based unit.

The second carbon dioxide electrolyzer 277 is configured to electrochemically reduce carbon dioxide to a hydrocarbon stream 295 comprising a hydrocarbon such as methane, ethene, or ethane, or a mixture thereof. System 275 is configured to deliver this hydrocarbon or mixture to a carburizing zone of DR furnace 278 and, optionally, deliver a portion of stream 295 to the reduction zone of furnace 278.

Carbon by weight percent is valued in the downstream melting process. DRI typically has a carbon content of about 1.5% or higher. To achieve this, natural gas is added into the transition zone within the lower cone of the furnace. Here, carbon is added onto the DRI by cracking of the CH₄ and other hydrocarbons to deposit carbon and generate hydrogen. Carbon is also deposited by the Bouduoard reaction (2CO->CO₂+C). Because hydrogen-based reduction strategies reduce CO₂ emissions by removing carbon compounds (CH₄, CO, and CO₂) from the gas stream, the carbon deposited by these reactions decreases at higher levels of hydrogen use. With the ability to recycle CO₂ in the electrolyzer, this is no longer a constraint. The electrolyzer can use the CO₂ captured to create a carburizing gas containing, e.g., a mixture of CO, CH₄, ethane, ethene and other compounds. C₂ and higher hydrocarbons are particularly effective as their carbon deposition reactions do not have chemical equilibrium limits. Further, with electrochemically formed methane, traditional carbon levels can be reached without the associated increase in Scope 1 CO₂ emissions.

Existing natural gas-based plants stand to benefit as well. In addition to reducing overall CO₂ emissions from the direct reduction process, electrolytic CO can give plants more flexibility around their operations especially as hydrogen addition is used to replace CH₄. For example, there exist situations where a plant can generate too much top gas fuel and so the excess gas must be flared. In this situation, the top gas fuel can be directed to a CO₂ electrolyzer and where it can be reconverted to syngas for reduction. In another example, catalyst within the reformer is sensitive to the inlet gas composition and must avoid situations where carbon might form and break down the catalyst. For hydrogen only addition, the reformer must be made to operate over a wide range of H:C ratios for the inlet gas. Addition of electrolytic CO either upstream or downstream to the reformer can provide extra flexibility to remain at conventional H:C ratios for longer when reducing natural gas to the process. FIG. 2C above shows an example of how one or more electrolyzers can be used to augment an existing reformer-based system. This can be used to reduce the burden of an aging reformer system, by extending the lifetime of reformer catalyst and tubes or to expand syngas capacity for an existing plant.

Further, as the industry moves from syngas toward hydrogen-based direct reduction, this system can be used to counteract some of the difficulties associated with that transition. One difficulty is in managing the DRI carbon percent. Conventionally produced DRI has carbon levels around 1.5-4% by weight and having this level improves melting performance within an electric arc furnace (EAF) used to improve the quality of the DRI. The DRI carbon enables the reduction of residual FeO within the molten bath, increasing steel yield. The carbon also provides chemical energy to minimize the presence of cold spots in the EAF with oxygen blowing resulting in higher productivity. For a fully hydrogen-based process, there is no carbon present on the DRI, and performance of the EAF degrades and even with the introduction of natural gas within the transition zone, only levels around 1% by weight carbon can be reached.

Further, existing plants transitioning to hydrogen-based direct reduction may be limited in maximum hydrogen replacement before reaching gas compression limitations. Hydrogen, a small molecule with a very low molecular weight, is much harder to compress than the conventional syngas compositions. Further, because the reduction of H₂ is endothermic, while CO reduction is exothermic, the overall flow gas flow rate must increase to supply the energy required for reduction. These effects combine and limit the overall capacity for plants at 100% hydrogen.

Through the addition of electrolytic CO, conventional plant compositions can be maintained throughout the entire transition away from natural gas. The examples included show examples for what a “fully circular” direct reduction process looks like with integrated H₂, CO, and CH₄ based electrolysis.

While DRI process embodiments described herein refer to a shaft furnace for carrying out the reduction of iron ore, other furnace types may be substituted for shaft furnaces. Alternative furnaces for carrying out reduction using a reducing and/or carburizing gas include batch furnaces and fluidized bed furnaces. Other furnace types known in the art may also be used.

### Downstream Steel Mill Operations

Downstream operations present various issues for CO₂ capture and utilization. With exception of the EAF, carbon emissions here are primarily for heating used to shape and treat the final steel products. This means for these operations, many can be potentially electrified as part of the transition and so carbon capture, may be realized primarily in preexisting units found in facilities.

The EAF on the other hand is unable to eliminate carbon within today's technology. Melting properties are affected. Cycle times and productivity of the EAF are diminished as well. While most of the heat comes from the electric arc, oxygen is used to reduce cold spots and improve overall cycle times.

The main difficulty in this area of the plant is that unlike upstream operations, flows here are not continuous. EAF is batch-based process, and heat-treating steps are run to meet desired criteria for specific product runs. Carbon dioxide electrolyzers are well-suited to capture and reduce such non-continuous CO₂ emissions.

In some embodiments, a steel making facility having an iron reduction reactor and a carbon dioxide electrolyzer such as depicted in any of FIGS. 1B, 1C, 2B, 2C, and 2D is integrated with one or more post processing units such as an electric arc furnace or a steel shaping system such as a steel rolling unit or a steel tempering unit. In some embodiments, CO₂ emitted by one or more post processing units is provided as an input to the carbon dioxide electrolyzer.

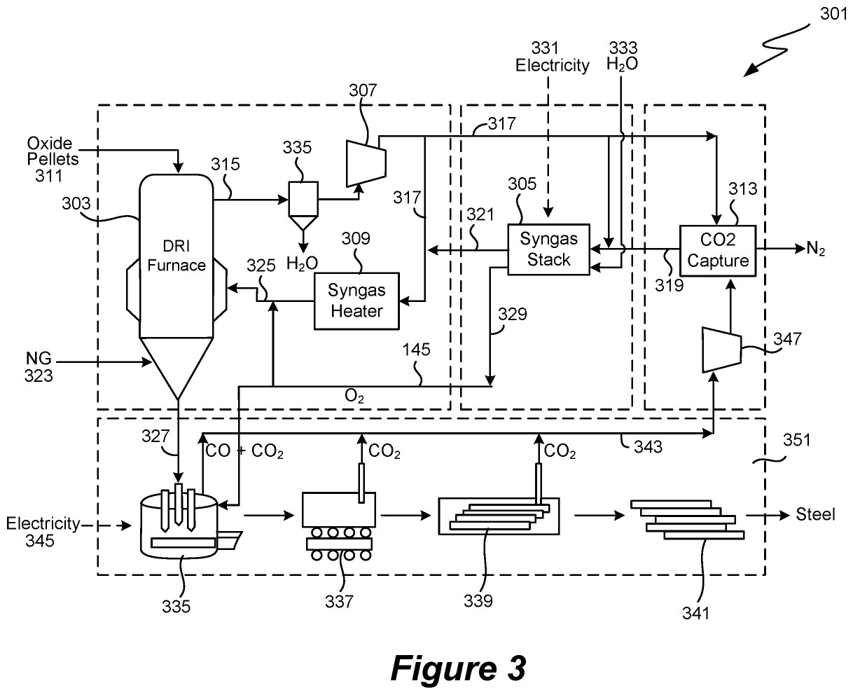

FIG. 3 illustrates an example of such an integrated system. As depicted an integrated system 301 includes a DR furnace 303, a carbon dioxide electrolyzer 305, and one or more post processing units 351. DR furnace 303 is configured to receive iron oxide or ore (e.g., in the form of pellets), reduce the iron oxide using a reducing gas 325 (at a reduction zone), carburize the resulting iron using a carburizing gas such as natural gas 323 (at a carburization zone), and output sponge iron or a related material 327 and output top gas 315.

System 301 includes top gas purifier or scrubber 335 (e.g., a water scrubber) configured to separate water and particles from the top gas. System 301 also includes a gas compressor 307 configured to pressurize the top gas and output a process gas 317. System 301 is also configured to transport some of process gas 317 to a heater 309, which heats the process gas before it is delivered to a reduction zone of furnace 303. System 301 is also configured to provide some of top gas 317 as an input to carbon dioxide electrolyzer 305.

Carbon dioxide electrolyzer 305 is configured to receive carbon dioxide, water 333, and electricity 331, and output a carbon monoxide containing stream 321 and oxygen 329. The carbon dioxide may come from a CO₂ purification unit 313 (via a stream 319) and/or from top gas stream 317. CO₂ purification unit 313 may be configured to receive compressed CO₂ generated by post processing units 351 via a compressor 347. Units 351 may collectively produce a CO₂ stream 343. CO₂ purification unit 313 may be further configured to receive compressed top gas 317. Regardless of the source, CO₂ purification unit 313 produces purified CO₂ stream 319, which is delivered to the cathode side of electrolyzer 305. Electrolyzer 305 may be configured to generate one or more additional carbon containing products besides CO. These additional products may include one or more hydrocarbons and/or hydrogen. Electrolyzer 305 may also be configured to produce molecular oxygen, which is represented by a stream 329.

In certain embodiments, the post processing units 351 include an electric arc furnace (EAF) 355, a steel rolling unit 337, a steel tempering unit 339, or any combination thereof. These units output finished steel product 341. Any one or more of these units may utilize a reaction such as combustion to generate heat. The reaction(s) output carbon dioxide, which is included in stream 343. EAF 355 is configured to receive direct reduced iron 327, electricity 345, and optionally oxygen from stream 329. During steel making, EAF 355 produces an improved steel product, which may be subject to one or more additional post processing operations and gives off a mixture of carbon monoxide and carbon dioxide, which may be provided to electrolyzer 305 via stream 343.

### Example Carbon Oxide Electrolyzer—Steelmaking Unit Operations Integration Schemes

A few example embodiments follow.

Blast Furnace process
Principal components of the system: a blast furnace (where the iron ore is reduced), a coker to produce coke for the blast furnace, a source of heated and pressurized air, one or more electrolyzers, and an optional CO₂ separation unit
Reactor: blast furnace
Inputs to top of reactor: iron ore, coke, and flux/limestone
Inputs near bottom of reactor: heated and pressurized air and fuel (oil or natural gas)
Outputs: liquid pig iron, coke oven gas (COG), and blast furnace gas (BFG). The COG and BFG are collectively “off gas,” which contains waste CO₂. The off gas is optionally combusted to provide additional heat to the process.
Role(s) of electrolyzer(s):
   receive and reduce CO₂ from combustion from heating air before it enters the blast furnace
   receive and reduce CO₂ from COG and/or BFG generated by the coke oven and/or the blast furnace
   generate syngas to supplement or replace coke as a reducing agent in the blast furnace
   generate CO, CH₄, C₂H₄ or other raw material for use in non-steelmaking applications; if a product other than CO is generated, the electrolyzer system may employ two electrolyzers (or groups of electrolyzers), one optimized to produce CO and another optimized to produce hydrocarbons.
Type(s) of electrolyzer(s) (any one or two of these as dictated by integration scheme):
   CO₂ reduction reactor configured to produce CO for syngas to be provided to the reactor (e.g., an electrolyzer having gold or other noble metal cathode catalyst)
   CO₂ reduction reactor configured to produce hydrocarbon and/or other non-CO product to be used in a non-steelmaking application (e.g., an electrolyzer having copper or other transition metal cathode catalyst)

### DRI Process (Syngas—External Reformer)

Principal components of the system: a DR furnace (e.g., a shaft furnace where the DRI process takes place), an external reformer, and one or more electrolyzers.
Reactor: shaft furnace
Inputs: iron ore, syngas, and some methane or other hydrocarbon. The syngas may be produced by the reformer and/or by the electrolyzer(s). The methane may also act as a source of carbon in the iron and/or to shift the CO+H₂->CH₄ reaction toward maintaining a sufficiently high conc of CO+H₂ for reducing the iron ore.
Reaction: reaction of iron ore with syngas to produce sponge iron
Outputs: sponge iron (solid which may be in the form of briquettes) and top gas fuel, which may be combusted to generate heat for process gas; the combusted top gas fuel contains some CO₂.
   Temperature: at least 700 C; more typically at 800-950 C
   Source of carbon in the DRI produced by the furnace:
      Mechanism 1: CO in low temperature reaction. CO reacts via the Boudouard reaction: 2CO->CO₂+C). For some applications, low temperature is not ideal because the iron reduction reaction slows with decreasing temperature and because higher temperatures allow production of sponge iron briquettes which are easier and safer to transport than non-briquetted sponge iron. For these reasons, most DRI processes operate at higher temperatures. But at such temperatures, the Boudouard reaction may not provide enough carbon in the steel product.
      Mechanism 2: At high reaction temperatures, methane and/or another hydrocarbon such as ethene reacts in way that provides sufficient carbon to the iron product. Therefore, for high temperature DRI processes, some methane may be included along with syngas.
   Role of electrolyzer(s):
      Receive and reduce CO₂ from combusted top gas fuel
      Generate syngas for input to DRI reactor (reduction zone)
      Generate methane and/or ethene for input to the DRI reactor transition zone
      Generate CO products for non-steelmaking industrial processes
      Generate non-CO products for non-steelmaking industrial processes
Type(s) of electrolyzer(s) (any one, two, or three of these, as dictated by integration scheme):
   CO₂ reduction reactor configured to produce CO for syngas to be provided to the reactor (e.g., an electrolyzer having gold or other noble metal cathode catalyst)
   CO₂ reduction reactor configured to produce hydrocarbon to be introduced, along with syngas, to the reactor and serve as a source of carbon in the sponge iron (e.g., an electrolyzer having copper or other transition metal cathode catalyst)
   Water electrolyzer configured to produce H₂, as needed, for introduction with CO into the reactor

### DRI Process (Syngas—In Situ Reforming)

Principal components of the system: a DR furnace (where the DRI process takes place) and one or more electrolyzers.
Reactor: a DR furnace (e.g., a shaft furnace)
Inputs: iron ore and some methane
Reaction: the methane reacts in situ (in the DR furnace) via a reforming reaction to produce CO and H₂, which reacts with iron ore to produce the sponge iron
Outputs: sponge iron (solid) and top gas fuel, which when optionally combusted contains some CO₂, alternatively, the top gas fuel can be reacted to produce syngas.
Temperature: same as external reformer DRI example
Source of carbon in steel: methane and/or ethene, as described for the external reformer DRI example
Role of electrolyzer(s):
   Receive and reduce CO₂ from combusted top gas fuel
   Generate methane and/or ethene for input to the DRI reactor
   Generate CO for non-steelmaking industrial processes
   Generate non-CO products for non-steelmaking industrial processes
Type(s) of electrolyzer(s) (any one or two of these as dictated by integration scheme):
   CO₂ reduction reactor configured to produce CO for syngas to be used in a non-steelmaking application (e.g., an electrolyzer having gold or other noble metal cathode catalyst)
   CO₂ reduction reactor configured to produce hydrocarbon to be introduced to the reactor and serve as a source of carbon in the sponge iron (e.g., an electrolyzer having copper or other transition metal cathode catalyst)
   CO₂ reduction reactor configured to produce non-CO product to be used in a non-steelmaking application

### DRI Process (Hydrogen)

Principal components of the system: a DR furnace (where the DRI process takes place) and one or more electrolyzers such as water electrolyzers. In some embodiments, one or more reformers to produce H₂ for introduction to the reactor.
Reactor: e.g., shaft furnace
Inputs: iron ore and hydrogen
Reaction: reduction of iron ore with hydrogen to produce sponge iron
Outputs: sponge iron (solid) and water
Temperature: same as external reformer DRI example
Source of carbon in steel: methane and/or ethene, as described for the external reformer DRI example
Role of electrolyzer(s):
   Generate hydrogen via water electrolyzer
   Generate methane and/or ethene as a source of carbon in the sponge iron
Type(s) of electrolyzer(s) (any one or two of these as dictated by integration scheme):
   Water electrolyzer to produce H₂ for the DRI reduction reaction
   CO₂ reduction reactor configured to produce hydrocarbon to be introduced to the reactor and serve as a source of carbon in the sponge iron (e.g., an electrolyzer having copper or other transition metal cathode catalyst)

### Electric Arc Furnace

Principal components of the system: furnace with three electrodes and one or more electrolyzers
Inputs: scrap steel and/or sponge iron from DRI or hydrogen-based iron process and electricity
Outputs: usable steel and some CO₂ and some CO
Role of electrolyzer(s):
   Receive and reduce CO₂ from electric arc furnace
   Generate methane and/or ethene for input to another steelmaking process such as a DRI reactor
   Generate syngas for input to another steelmaking process such as a DRI reactor
   Generate CO for non-steelmaking industrial processes
   Generate non-CO products for non-steelmaking industrial processes
Type(s) of electrolyzer(s) (any one or two of these as dictated by integration scheme):
   CO₂ reduction reactor configured to produce CO (e.g., an electrolyzer having gold or other noble metal cathode catalyst)
   CO₂ reduction reactor configured to produce hydrocarbon and/or other non-CO product (e.g., an electrolyzer having copper or other transition metal cathode catalyst)

### Downstream Processes

Principal components of system: rolling and heat treatment apparatus
Inputs: steel from EAF or blast furnace and fuel (natural gas and other fossil fuels) for combustion
Outputs: usable steel products and some CO₂
Role of electrolyzer(s):
   Receive and reduce CO₂ from fossil fuel combustion that produces heat for downstream processes
   Generate methane and/or ethene for input to another steelmaking process such as a DRI reactor
   Generate syngas for input to another steelmaking process such as a DRI reactor
   Generate CO for non-steelmaking industrial processes
   Generate non-CO products for non-steelmaking industrial processes
Type(s) of electrolyzer(s) (any one or two of these as dictated by integration scheme):
   CO₂ reduction reactor configured to produce CO (e.g., an electrolyzer having gold or other noble metal cathode catalyst)
   CO₂ reduction reactor configured to produce a hydrocarbon and/or other non-CO product (e.g., an electrolyzer having copper or other transition metal cathode catalyst)

### Example Carbon Oxide Electrolyzer—Steelmaking Implementations

Implementation example 1: A DRI production system in which little or no Scope 1 CO₂ is emitted. All or nearly all CO₂ generated from the top gas fuel and/or its combustion products (e.g., at least 50% by weight) are consumed by a CO₂ electrolyzer and converted to CO and/or hydrocarbon (CH₄ and/or C₂H₄), which is/are optionally recycled to the DRI reactor. In some cases, the DRI system actually consumes external CO₂. This may be the case where carbon from external CO₂ is needed to reach a desired carbon content in the DRI sponge iron.

Implementation example 2: A DRI production system in which two or more electrolyzers of different types operate in parallel. In one case, a CO₂ to CO electrolyzer operates in parallel with water electrolyzer. CO from the CO₂ electrolyzer is combined with H₂ from the water electrolyzer to produce syngas for injection into the DRI reactor. In another case, a CO₂ to CO electrolyzer operates in parallel with a CO₂ to hydrocarbon electrolyzer. CO and optionally some H₂ from the first CO₂ electrolyzer is used in reduction zone and hydrocarbon (CH₄ and/or C₂H₄) from the second electrolyzer is used in the carburization zone for injection into the DRI reactor. Optionally, hydrocarbon from the second electrolyzer is also used in the reduction zone. The hydrocarbon may serve as a source of carbon for the sponge iron from the DRI process. In some cases, a CO₂ to CO electrolyzer operates in parallel with a water electrolyzer and a CO₂ to hydrocarbon electrolyzer. CO and H₂ from the first two electrolyzers provides syngas for injection to the DRI reactor, and hydrocarbon from the third electrolyzer provides a carbon source for sponge iron produced by the DRI reactor.

Implementation 3: A DRI production system having a CO₂ to C₂H₄ electrolyzer. The C₂H₄ is injected into the DRI reactor to provide an additional source of carbon for the sponge iron reach a desired carbon concentration. In some cases, the sponge iron has a carbon concentration of about 1.5 to 2.5% by weight.

### Carbon Oxide Electrolyzer Design and Operating Conditions

A carbon oxide electrolyzer's design and operating conditions can be tuned for particular applications. Often this involves designing or operating the electrolyzer in a manner that produces a cathode output having specified compositions. In some implementations, one or more general principles may be applied to operate an electrolyzer in a way that produces a required output stream composition.

High CO₂ Reduction Product (Particularly CO) to CO₂ Ratio Operating Parameter Regime

In certain embodiments, an electrolyzer is configured to produce, and when operating actually produce, an output stream having a CO:CO₂ molar ratio of at least about 1:1 or at least about 1:2 or at least about 1:3. A high CO output stream may alternatively be characterized as having a CO concentration of at least about 25 mole %, or at least about 33 mole %, or at least about 50 mole %.

In certain embodiments, this high carbon monoxide output concentration is obtained by operating a carbon dioxide electrolyzer in a manner that produces any one of or any combination of the following operating conditions:
a current density of at least about 300 mA/cm², at the cathode,
a CO₂ stoichiometric flow rate (as described elsewhere herein) of at most about 4, or at most about 2.5, or at most about 1.5,
a temperature of at most about 80° C. or at most about 65° C.,
a pressure range of about 75 to 400 psig,
an anode water composition of about 0.1 to 50 mM bicarbonate salt, and
an anode water pH of at least about 1.

In certain embodiments, the electrolyzer may be built to favor high CO:CO₂ molar ratios or concentrations, as defined here, by using a carbon dioxide electrolyzer having any one of or any combination of the following properties:
relatively small nanoparticle cathode catalysts (e.g., having largest dimensions of, on average, about 0.1-15 nm),
gold as the cathode catalyst material,
a cathode catalyst layer thickness of about 5-20 um,
a cathode gas diffusion layer (GDL) with a microporous layer (MPL),
a cathode GDL with PTFE present at about 1-20 wt %, or about 1-10 wt %, or about 1-5 wt %,
a GDL that has a thickness of at least about 200 um,
a bipolar MEA having an anion-exchange cathode buffer layer having a thickness of at least about 5 um, and
a cathode flow field having parallel and/or serpentine flow paths.

### High Reduction Product to Hydrogen Product Stream Operating Parameter Regime

In certain embodiments, a carbon dioxide electrolyzer is configured to produce, and when operating actually produces, an output stream having CO:H₂ in a molar ratio of at least about 2:1.

In certain embodiments, such product rich output concentration is obtained by operating a carbon dioxide electrolyzer in a manner that produces any one of or any combination of the following operating conditions:
a current density at the cathode of at least about 300 mA/cm²,
a CO₂ mass transfer stoichiometric flow rate to the cathode of at least about 1.5, or at least about 2.5, or at least about 4,
a temperature of at most about 80° C.,
a pressure in the range of about 75 to 400 psig,
an anode water composition of about 0.1 mM to 50 mM bicarbonate salt, and
an anode water pH of greater than about 1.

In certain embodiments, the electrolyzer may be built to favor product-rich molar ratios or concentrations, as defined here, by using a carbon dioxide electrolyzer having any one of or any combination of the following properties:
relatively small nanoparticle catalysts (e.g., having largest dimensions of, on average, about 0.1-15 nm),
gold as the cathode catalyst material,
a cathode catalyst layer thickness of about 5-20 um,
a cathode gas diffusion layer with a microporous layer (MPL),
a cathode GDL with PTFE present at about 1-20 wt %, or about 1-10 wt %, or about 1-5 wt %,
a cathode GDL that has a thickness of at least about 200 um, and
a bipolar MEA having an anion-exchange layer with a thickness of at least about 5 um.

### Hydrocarbon Reduction Product

In energy conversion processes that require methane and/or ethene inputs, a carbon oxide electrolyzer may be designed to favor production of these hydrocarbons. In some embodiments, the electrolyzer cathode employs a transition metal such as copper as a reduction catalyst. See for example PCT Patent Application Publication No. 2020/146402, published Jul. 16, 2020, and titled “SYSTEM AND METHOD FOR METHANE PRODUCTION,” which is incorporated herein by reference in its entirety. Electrolysis systems for producing ethene may be configured to recycle some hydrocarbon product of a carbon oxide electrolyzer back to the cathode and/or provide two more electrolyzers operating in series, with the cathode output of a first electrolyzer feeding the input to a cathode of a second electrolyzer. See for example PCT Patent Application No. PCT/US2021/036475, filed Jun. 8, 2021, and titled “SYSTEM AND METHOD FOR HIGH CONCENTRATION OF MULTIELECTRON PRODUCTS OR CO IN ELECTROLYZER OUTPUT,” which is incorporated herein by reference in its entirety.

### Hydrocarbon Reduction Product

In steelmaking operations that require methane and/or ethene inputs, a carbon oxide electrolyzer may be designed to favor production of these hydrocarbons. In some embodiments, the electrolyzer cathode employs a transition metal such as copper as a reduction catalyst. See for example PCT Patent Application Publication No. 2020/146402, published Jul. 16, 2020, and titled “SYSTEM AND METHOD FOR METHANE PRODUCTION,” which is incorporated herein by reference in its entirety. Electrolysis systems for producing ethene may be configured to recycle some hydrocarbon product of a carbon oxide electrolyzer back to the cathode and/or provide two more electrolyzers operating in series, with the cathode output of a first electrolyzer feeding the input to a cathode of a second electrolyzer. See for example PCT Patent Application No. PCT/US2021/036475, filed Jun. 8, 2021, and titled “SYSTEM AND METHOD FOR HIGH CONCENTRATION OF MULTIELECTRON PRODUCTS OR CO IN ELECTROLYZER OUTPUT,” which is incorporated herein by reference in its entirety.

### Carbon Oxide Electrolyzer Embodiments

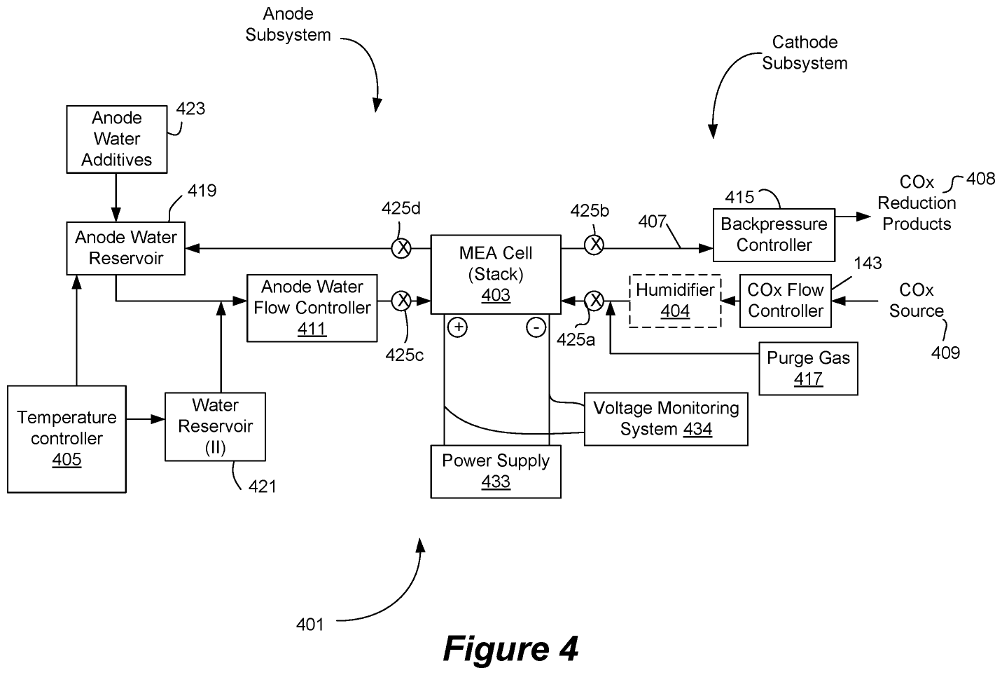

FIG. 4 depicts an example system 401 for a carbon oxide reduction reactor or electrolyzer 403 that may include a cell comprising a MEA (membrane electrode assembly). The reactor may contain multiple cells or MEAS arranged in a stack. System 401 includes an anode subsystem that interfaces with an anode of electrolyzer 403 and a cathode subsystem that interfaces with a cathode of electrolyzer 403. System 401 is an example of a system that may be used with or to implement any of the methods or operating conditions described above.

As depicted, the cathode subsystem includes a carbon oxide source 409 configured to provide a feed stream of carbon oxide to the cathode of electrolyzer 403, which, during operation, may generate an output stream 408 that includes product(s) of a reduction reaction at the cathode. The product stream 408 may also include unreacted carbon oxide and/or hydrogen.

The carbon oxide source 409 is coupled to a carbon oxide flow controller 413 configured to control the volumetric or mass flow rate of carbon oxide to electrolyzer 403. One or more other components may be disposed on a flow path from flow carbon oxide source 409 to the cathode of electrolyzer 403. For example, an optional humidifier 404 may be provided on the path and configured to humidify the carbon oxide feed stream. Humidified carbon oxide may moisten one or more polymer layers of an MEA and thereby avoid drying such layers. Another component that may be disposed on the flow path is a purge gas inlet coupled to a purge gas source 417. In certain embodiments, purge gas source 417 is configured to provide purge gas during periods when current is paused to the cell(s) of electrolyzer 403. In some implementations, flowing a purge gas over an MEA cathode facilitates recovery of catalyst activity and/or selectivity. Examples of purge gases include carbon dioxide, carbon monoxide, hydrogen, nitrogen, argon, helium, oxygen, and mixtures of any two or more of these. Further details of MEA cathode purge processes and systems are described in US Patent Application Publication No. 20220267916, published Aug. 25, 2022, which is incorporated herein by reference in its entirety.

During operation, the output stream from the cathode flows via a conduit 407 that connects to a backpressure controller 415 configured to maintain pressure at the cathode side of the cell within a defined range (e.g., about 50 to 800 psig, depending on the system configuration). The output stream may provide the reaction products 408 to one or more components (not shown) for separation and/or concentration.

In certain embodiments, the cathode subsystem is configured to controllably recycle unreacted carbon oxide from the outlet stream back to the cathode of electrolyzer 403. In some implementations, the output stream is processed to remove reduction product(s) and/or hydrogen before recycling the carbon oxide. Depending upon the MEA configuration and operating parameters, the reduction product(s) may be carbon monoxide, hydrogen, hydrocarbons such as methane and/or ethylene, oxygen-containing organic compounds such as formic acid, acetic acid, and any combinations thereof. In certain embodiments, one or more components, not shown, for removing water from the product stream are disposed downstream form the cathode outlet. Examples of such components include a phase separator configured to remove liquid water from the product gas stream and/or a condenser configured to cool the product stream gas and thereby provide a dry gas to, e.g., a downstream process when needed. In some implementations, recycled carbon oxide may mix with fresh carbon oxide from source 409 upstream of the cathode.

As depicted in FIG. 4, an anode subsystem is configured to provide an anode feed stream to an anode side of the carbon oxide electrolyzer 403. In certain embodiments, the anode subsystem includes an anode water source, not shown, configured to provide fresh anode water to a recirculation loop that includes an anode water reservoir 419 and an anode water flow controller 411. The anode water flow controller 411 is configured to control the flow rate of anode water to or from the anode of electrolyzer 403. In the depicted embodiment, the anode water recirculation loop is coupled to components for adjusting the composition of the anode water. These may include a water reservoir 421 and/or an anode water additives source 423. Water reservoir 421 is configured to supply water having a composition that is different from that in anode water reservoir 419 (and circulating in the anode water recirculation loop). In one example, the water in water reservoir 421 is pure water that can dilute solutes or other components in the circulating anode water. Pure water may be conventional deionized water even ultrapure water having a resistivity of, e.g., at least about 15 MOhm-cm or over 18.0 MOhm-cm. Anode water additives source 423 is configured to supply solutes such as salts and/or other components to the circulating anode water. Examples of anode water salts for various carbon oxide electrolyzer configurations are presented in US Patent Application Publication No. 20200240023, published Jul. 30, 2020, which is incorporated herein by reference in its entirety.

During operation, the anode subsystem may provide water or other reactant to the anode of electrolyzer 403, where it at least partially reacts to produce an oxidation product such as oxygen. The product along with unreacted anode feed material is provided in a reduction reactor outlet stream. Not shown in FIG. 4 is an optional separation component that may be provided on the path of the anode outlet stream and configured to concentrate or separate the oxidation product from the anode product stream.

Other control features may be included in system 401. For example, a temperature controller may be configured to heat and/or cool the carbon oxide electrolyzer 403 at appropriate points during its operation. In the depicted embodiment, a temperature controller 405 is configured to heat and/or cool anode water provided to the anode water recirculation loop. For example, the temperature controller 405 may include or be coupled to a heater and/or cooler that may heat or cool water in anode water reservoir 419 and/or water in reservoir 421. In some embodiments, system 401 includes a temperature controller configured to directly heat and/or cool a component other than an anode water component. Examples of such other components in the cell or stack and the carbon oxide flowing to the cathode.

Depending upon the phase of the electrochemical operation, including whether current is paused to carbon oxide reduction electrolyzer 403, certain components of system 401 may operate to control non-electrical operations. For example, system 401 may be configured to adjust the flow rate of carbon oxide to the cathode and/or the flow rate of anode feed material to the anode of electrolyzer 403. Components that may be controlled for this purpose may include carbon oxide flow controller 413 and anode water controller 411.

In addition, depending upon the phase of the electrochemical operation including whether current is paused, certain components of system 401 may operate to control the composition of the carbon oxide feed stream and/or the anode feed stream. For example, water reservoir 421 and/or anode water additives source 423 may be controlled to adjust the composition of the anode feed stream. In some cases, additives source 423 may be configured to adjust the concentration of one or more solutes such as one or more salts in an aqueous anode feed stream.

In some cases, a temperature controller such controller 405 is configured to adjust the temperature of one or more components of system 401 based on a phase of operation. For example, the temperature of cell 403 may be increased or decreased during break-in, a current pause in normal operation, and/or storage.

In some embodiments, a carbon oxide electrolytic reduction system is configured to facilitate removal of a reduction cell from other system components. This may be useful with the cell needs to be removed for storage, maintenance, refurbishment, etc. In the depicted embodiments, isolation valves 425a and 425b are configured to block fluidic communication of cell 403 to a source of carbon oxide to the cathode and backpressure controller 415, respectively. Additionally, isolation valves 425c and 425d are configured to block fluidic communication of cell 403 to anode water inlet and outlet, respectively.

The carbon oxide reduction electrolyzer 403 may also operate under the control of one or more electrical power sources and associated controllers. See, block 433. Electrical power source and controller 433 may be programmed or otherwise configured to control current supplied to and/or to control voltage applied to the electrodes in reduction electrolyzer 403. The current and/or voltage may be controlled to execute the current schedules and/or current profiles described elsewhere herein. For example, electrical power source and controller 433 may be configured to periodically pause current applied to the anode and/or cathode of reduction electrolyzer 403. Any of the current profiles described herein may be programmed into power source and controller 433.

In certain embodiments, electric power source and controller 433 performs some but not all the operations necessary to implement desired current schedules and/or profiles in the carbon oxide reduction electrolyzer 403. A system operator or other responsible individual may act in conjunction with electrical power source and controller 433 to fully define the schedules and/or profiles of current applied to reduction electrolyzer 403. For example, an operator may institute one or more current pauses outside the set of current pauses programmed into power source and controller 433.

In certain embodiments, the electrical power source and an optional, associated electrical power controller acts in concert with one or more other controllers or control mechanisms associated with other components of system 401. For example, electrical power source and controller 433 may act in concert with controllers for controlling the delivery of carbon oxide to the cathode, the delivery of anode water to the anode, the addition of pure water or additives to the anode water, and any combination of these features. In some implementations, one or more controllers are configured to control or operate in concert to control any combination of the following functions: applying current and/or voltage to reduction cell 403, controlling backpressure (e.g., via backpressure controller 415), supplying purge gas (e.g., using purge gas component 417), delivering carbon oxide (e.g., via carbon oxide flow controller 413), humidifying carbon oxide in a cathode feed stream (e.g., via humidifier 404), flow of anode water to and/or from the anode (e.g., via anode water flow controller 411), and anode water composition (e.g., via anode water source 405, pure water reservoir 421, and/or anode water additives component 423).

In the depicted embodiment, a voltage monitoring system 434 is employed to determine the voltage across an anode and cathode of an MEA cell or across any two electrodes of a cell stack, e.g., determining the voltage across all cells in a multi-cell stack. The voltage determined in this way can be used to control the cell voltage during a current pause, inform the duration of a pause, etc. In certain embodiments, voltage monitoring system 434 is configured to work in concert with power supply 433 to cause reduction cell 403 to remain within a specified voltage range. For example, power supply 433 may be configured to apply current and/or voltage to the electrodes of reduction cell 403 in a way that maintains the cell voltage within a specified range during a current pause. If, for example during a current pause, the cell's open circuit voltage deviates from a defined range (as determined by voltage monitoring system 434), power supply may be configured to apply current or voltage to the electrodes to maintain the cell voltage within the specified range.

An electrolytic carbon oxide reduction system such as that depicted in FIG. 4 may employ control elements or a control system that includes one or more controllers and one or more controllable components such as pumps, sensors, dispensers, valves, and power supplies. Examples of sensors include pressure sensors, temperature sensors, flow sensors, conductivity sensors, voltmeters, ammeters, electrolyte composition sensors including electrochemical instrumentation, chromatography systems, optical sensors such as absorbance measuring tools, and the like. Such sensors may be coupled to inlets and/or outlets of an MEA cell (e.g., in a flow field), in a reservoir for holding anode water, pure water, salt solution, etc., and/or other components of an electrolytic carbon oxide reduction system.

Among the various functions that may be controlled by one or more controllers are: applying current and/or voltage to a carbon oxide reduction cell, controlling backpressure on an outlet from a cathode on such cell, supplying purge gas to a cathode inlet, delivering carbon oxide to the cathode inlet, humidifying carbon oxide in a cathode feed stream, flowing anode water to and/or from the anode, and controller anode feed composition. Any one or more of these functions may have a dedicated controller for controlling its function alone. Any two or more of these functions may share a controller. In some embodiments, a hierarchy of controllers is employed, with at least one master controller providing instructions to two or more component controllers. For example, a system may comprise a master controller configured to provide high level control instructions to (i) a power supply to a carbon oxide reduction cell, (ii) a cathode feed stream flow controller, and (iii) an anode feed stream flow controller. For example, a programmable logic controller (PLC) may be used to control individual components of the system.

In certain embodiments, a control system is configured to control the flow rate of one or more feed streams (e.g., a cathode feed stream such as a carbon oxide flow and an anode feed stream) in concert with a current schedule. For example, the flow of carbon oxide or a purge gas may be turned on, turned off, or otherwise adjusted when current applied to an MEA cell is reduced, increased, or paused.

A controller may include any number of processors and/or memory devices. The controller may contain control logic such software or firmware and/or may execute instructions provided from another source. A controller may be integrated with electronics for controlling operation the electrolytic cell before, during, and after reducing a carbon oxide. The controller may control various components or subparts of one or multiple electrolytic carbon oxide reduction systems. The controller, depending on the processing requirements and/or the type of system, may be programmed to control any of the processes disclosed herein, such as delivery of gases, temperature settings (e.g., heating and/or cooling), pressure settings, power settings (e.g., electrical voltage and/or current delivered to electrodes of an MEA cell), liquid flow rate settings, fluid delivery settings, and dosing of purified water and/or salt solution. These controlled processes may be connected to or interfaced with one or more systems that work in concert with the electrolytic carbon oxide reduction system.

In various embodiments, a controller comprises electronics having various integrated circuits, logic, memory, and/or software that receive instructions, issue instructions, control operations described herein. The integrated circuits may include chips in the form of firmware that store program instructions, digital signal processors (DSPs), chips defined as application specific integrated circuits (ASICs), and/or one or more microprocessors, or microcontrollers that execute program instructions (e.g., software). Program instructions may be instructions communicated to the controller in the form of various individual settings (or program files), defining operational parameters for carrying out a process on one or more components of an electrolytic carbon oxide reduction system. The operational parameters may, in some embodiments, be part of a recipe defined by process engineers to accomplish one or more processing steps during generation of a particular reduction product such as carbon monoxide, hydrocarbons, and/or other organic compounds.

The controller, in some implementations, may be a part of or coupled to a computer that is integrated with, coupled to the system, otherwise networked to the system, or a combination thereof. For example, the controller may utilize instructions stored remotely (e.g., in the “cloud”) and/or execute remotely. The computer may enable remote access to the system to monitor current progress of electrolysis operations, examine a history of past electrolysis operations, examine trends or performance metrics from a plurality of electrolysis operations, to change parameters of current processing, to set processing steps to follow a current processing, or to start a new process. In some examples, a remote computer (e.g., a server) can provide process recipes to a system over a network, which may include a local network or the internet. The remote computer may include a user interface that enables entry or programming of parameters and/or settings, which are then communicated to the system from the remote computer. In some examples, the controller receives instructions in the form of data, which specify parameters for each of the processing steps to be performed during one or more operations.

The controller may be distributed, such as by comprising one or more discrete controllers that are networked together and working towards a common purpose, such as applying current to an MEA cell and other process controls described herein. An example of a distributed control system for such purposes includes one or more processors on a system for electrolytically reducing a carbon oxide and one or more processors located remotely (such as at the platform level or as part of a remote computer) that combine to control a process.

Controllers and any of various associated computational elements including processors, memory, instructions, routines, models, or other components are sometimes described or claimed as “configured to” perform a task or tasks. In such contexts, the phrase “configured to” is used to denote structure by indicating that the component includes structure (e.g., stored instructions, circuitry, etc.) that performs a task or tasks during operation. As such, a controller and/or associated component can be said to be configured to perform the task even when the specified component is not necessarily currently operational (e.g., is not on).

Controllers and other components that are “configured to” perform an operation may be implemented as hardware—for example, circuits, memory storing program instructions executable to implement the operation, etc. Additionally, controllers and other components “configured to” perform an operation may be implemented as hardware that is manipulated by software and/or firmware (e.g., an FPGA or a general-purpose processor executing software) to operate in manner that is capable of performing the recited task(s). Additionally, “configured to” can refer to one or more memories or memory elements storing computer executable instructions for performing the recited task(s). Such memory elements may include memory on a computer chip having processing logic.

Non-computation elements such as reactors such electrolyzers, membrane assemblies, layers, and catalyst particles may also be “configured” to perform certain functions. In such contexts, the phrase “configured to” indicate that the referenced structure has one or more features that allow the function to be performed. Examples of such features include physical and/or chemical properties such as dimensions, composition, porosity, etc.

### MEA Embodiments

### MEA Overview

In various embodiments, an MEA contains an anode layer, a cathode layer, electrolyte, and optionally one or more other layers. The layers may be solids and/or gels. The layers may include polymers such as ion-conducting polymers.

When in use, the cathode of an MEA promotes electrochemical reduction of COₓ by combining three inputs: COₓ, ions (e.g., hydrogen ions, bicarbonate ions, or hydroxide ions) that chemically react with COₓ, and electrons. The reduction reaction may produce CO, hydrocarbons, and/or hydrogen and oxygen-containing organic compounds such as methanol, ethanol, and acetic acid. When in use, the anode of an MEA promotes an electrochemical oxidation reaction such as electrolysis of water to produce elemental oxygen and protons. The cathode and anode may each contain catalysts to facilitate their respective reactions.

During operation of an MEA, ions move through a polymer-electrolyte, while electrons flow from an anode, through an external circuit, and to a cathode. In some embodiments, liquids and/or gas move through or permeates the MEA layers. This process may be facilitated by pores in the MEA.

The compositions and arrangements of layers in the MEA may promote high yield of a CO, reduction products. To this end, the MEA may facilitate any one or more of the following conditions: (a) minimal parasitic reduction reactions (non-COₓ reduction reactions) at the cathode; (b) low loss of COₓ reactants to the anode or elsewhere in the MEA; (c) physical integrity of the MEA during the reaction (e.g., the MEA layers remain affixed to one another); (d) prevent COₓ reduction product cross-over; (e) prevent oxidation product (e.g., O₂) cross-over; (f) a suitable environment at the cathode for the reduction reaction; (g) a pathway for desired ions to travel between cathode and anode while blocking undesired ions; and (h) low voltage operation.

### COₓ Reduction Considerations

For many applications, an MEA for COₓ reduction requires a lifetime on the order of about 50,000 hours or longer (approximately five years of continuous operation), which is significantly longer than the expected lifespan of a fuel cell for automotive applications; e.g., on the order of 5,000 hours. And for various applications, an MEA for COₓ reduction employs electrodes having a relatively large surface area by comparison to MEAS used for fuel cells in automotive applications. For example, MEAS for COₓ reduction may employ electrodes having surface areas (without considering pores and other nonplanar features) of at least about 500 cm².

COₓ reduction reactions may be implemented in operating environments that facilitate mass transport of particular reactant and product species, as well as to suppress parasitic reactions.

Fuel cell and water electrolyzer MEAs often cannot produce such operating environments. For example, such MEAs may promote undesirable parasitic reactions such as gaseous hydrogen evolution at the cathode and/or gaseous CO₂ production at the anode.

In some systems, the rate of a COₓ reduction reaction is limited by the availability of gaseous COₓ reactant at the cathode. By contrast, the rate of water electrolysis is not significantly limited by the availability of reactant: liquid water tends to be easily accessible to the cathode and anode, and electrolyzers can operate close to the highest current density possible.

### MEA Configurations

In certain embodiments, an MEA has a cathode layer, an anode layer, and a polymer electrolyte membrane (PEM) between the anode layer and the cathode layer. The polymer electrolyte membrane provides ionic communication between the anode layer and the cathode layer, while preventing electronic communication that would produce a short circuit. The cathode layer includes a reduction catalyst and, optionally, an ion-conducting polymer (sometimes called an ionomer). The cathode layer may also include an electron conductor and/or an additional ion conductor. The anode layer includes an oxidation catalyst and, optionally, an ion-conducting polymer. The anode layer may also include an electron conductor and/or an additional ion conductor. The PEM comprises an ion-conducting polymer. In certain embodiments, the MEA has a cathode buffer layer between the cathode layer and the polymer electrolyte membrane. The cathode buffer comprises an ion-conducting polymer.

The ion-conducting polymers in the PEM, the cathode, the anode, and the cathode buffer layer, if present, may each be different from one another in composition, conductivity, molecular weight, or other property. In some cases, two or more of these polymers are identical or substantially identical. For example, the ion-conducting polymer in the cathode and cathode buffer layer may be identical.

In certain embodiments, the MEA has an anode buffer layer between the anode layer and the polymer electrolyte membrane. The anode buffer layer also comprises an ion-conducting polymer, which may have the same properties as any of the other ion-conducting polymers (e.g., the ion-conducting polymer in the anode). Or the ion-conducting layer of the anode buffer layer may be different from every other ion-conducting layer in the MEA.

In connection with certain MEA designs, there may be three available classes of ion-conducting polymers: anion-conductors, cation-conductors, and mixed cation-and-anion-conductors. In certain embodiments, at least two of the first, second, third, fourth, and fifth ion-conducting polymers are from different classes of ion-conducting polymers.

In certain embodiments, an MEA has a bipolar interface, which means that it has one layer of anion-conducting polymer in contact with a layer of cation-conducting polymer. One example of an MEA with a bipolar interface is an anion-conducting cathode buffer layer adjacent to (and in contact with) a cation-conducting PEM. In certain embodiments, an MEA contains only anion-conducting polymer between the anode and the cathode. Such MEAs are sometimes referred to as “AEM only” MEAs. Such MEAs may contain one or more layers of anion-conducing polymer between the anode and the cathode.

### Ion-Conducting Polymers for MEA Layers

The term “ion-conducting polymer” or “ionomer” is used herein to describe a polymer that conducts ions (anions and/or cations) is to say that the material is an ion-conducting material or ionomer. In certain embodiments, an MEA contains one or more ion-conducting polymers having a specific conductivity of about 1 mS/cm or greater for anions and/or cations. The term “anion-conductor” describes an ion-conducting polymer that conducts anions primarily (although there will still be some small amount of cation conduction) and has a transference number for anions of about 0.85 or greater at around 100 micrometers thickness. The terms “cation-conductor” and/or “cation-conducting polymer” describe an ion-conducting polymer that conducts cations primarily (e.g., there can still be an incidental amount of anion conduction) and has a transference number for cations of about 0.85 or greater at about 100 micrometers thickness. For an ion-conducting polymer that is described as conducting both anions and cations (a “cation-and-anion-conductor”), neither the anions nor the cations have a transference number greater than about 0.85 or less than about 0.15 at about 100 micrometers thickness. Examples of ion-conducting polymers of each class are provided in the below Table 1.

Ion-Conducting Polymers

| | | Common | |
|---|---|---|---|
| Class | Description | Features | Examples |
| A. | Greater than | Positively | Quaternary |
| Anion- | approximately 1 | charged | ammonium |
| conduct- | mS/cm specific | functional | or cyclic amine |
| ing | conductivity for | groups are | moieties on |
| | anions, which | covalently | polyphenylene |
| | have a | bound to the | backbone; aminated |
| | transference | polymer | tetramethyl |
| | number greater | backbone | polyphenylene; |
| | than | | poly(ethylene-co- |
| | approximately | | tetrafluoroethylene)- |
| | 0.85 at about 100 | | based quaternary |
| | micron thickness | | ammonium polymer; |
| | | | quaternized |
| | | | polysulfone |
| B. | Greater than | Salt is | polyethylene oxide; |
| Conducts | approximately 1 | soluble in | polyethylene glycol; |
| both | mS/cm conductivity | the polymer | poly(vinylidene |
| anions and | for ions (including | and the salt | fluoride); |
| cations | both cations and | ions can move | polyurethane |
| | anions), which | through the | |
| | have a | polymer | |
| | transference | material | |
| | number between | | |
| | approximately | | |
| | 0.15 and 0.85 at | | |
| | around 100 micron | | |
| | thickness | | |
| C. | Greater than | Negatively | perfluorosulfonic |
| Cation- | approximately 1 | charged | acid polytetra- |
| conduct- | mS/cm specific | functional | fluoroethylene |
| ing | conductivity for | groups are | co-polymer; |
| | cations, which | covalently | sulfonated |
| | have a | bound to | poly(ether ketone); |
| | transference | the polymer | poly(styrene |
| | number greater | backbone | sulfonic acid- |
| | than | | co-maleic acid) |
| | approximately | | |
| | 0.85 at around 100 | | |
| | micron thickness | | |

### Polymeric Structures

Examples of polymeric structures that can include an ionizable moiety or an ionic moiety and be used as ion-conducting polymers (ionomers) in the MEAs described here are provided in US Patent Application Publication 20220119636, published Apr. 21, 2022, and titled “SEMI-INTERPENETRATING AND CROSSLINKED POLYMERS AND MEMBRANES THEREOF,” and in US Patent Application Publication 20220119641, published Apr. 21, 2022, and titled “IONIC POLYMERS AND COPOLYMERS,” each of which is incorporated herein by reference in its entirety. The ion-conducting polymers may be used as appropriate in any of the MEA layers that include an ion-conducting polymer. Charge conduction through the material can be controlled by the type and amount of charge (e.g., anionic and/or cationic charge on the polymeric structure) provided by the ionizable/ionic moieties. In addition, the composition can include a polymer, a homopolymer, a copolymer, a block copolymer, a polymeric blend, other polymer-based forms, or other useful combinations of repeating monomeric units. As described below, an ion conducting polymer layer may include one or more of crosslinks, linking moieties, and arylene groups according to various embodiments. In some embodiments, two or more ion conducting polymers (e.g., in two or more ion conducting polymer layers of the MEA) may be crosslinked.

### Bipolar MEA for COx Reduction

In certain embodiments, the MEA includes a bipolar interface having an anion-conducting polymer on the cathode side of the MEA and an interfacing cation-conducting polymer on the anode side of the MEA. In some implementations, the cathode contains a first catalyst and an anion-conducting polymer. In certain embodiments, the anode contains a second catalyst and a cation-conducting polymer. In some implementations, a cathode buffer layer, located between the cathode and PEM, contains an anion-conducting polymer. In some embodiments, an anode buffer layer, located between the anode and PEM, contains a cation-conducting polymer.

In embodiments employing an anion-conducting polymer in the cathode and/or in a cathode buffer layer, the MEA can decrease or block unwanted reactions that produce undesired products and decrease the overall efficiency of the cell. In embodiments employing a cation-conducting polymer in the anode and/or in an anode buffer layer can decrease or block unwanted reactions that reduce desired product production and reduce the overall efficiency of the cell.

For example, at levels of electrical potential used for cathodic reduction of CO₂, hydrogen ions may be reduced to hydrogen gas. This is a parasitic reaction; current that could be used to reduce CO₂ is used instead to reduce hydrogen ions. Hydrogen ions may be produced by various oxidation reactions performed at the anode in a CO₂ reduction reactor and may move across the MEA and reach the cathode where they can be reduced to produce hydrogen gas. The extent to which this parasitic reaction can proceed is a function of the concentration of hydrogen ions present at the cathode. Therefore, an MEA may employ an anion-conducting material in the cathode layer and/or in a cathode buffer layer. The anion-conducting material at least partially blocks hydrogen ions from reaching catalytic sites on the cathode. As a result, parasitic production of hydrogen gas decreases and the rate of production of CO or other carbon-containing product increases.

Another reaction that may be avoided is reaction of carbonate or bicarbonate ions at the anode to produce CO₂. Aqueous carbonate or bicarbonate ions may be produced from CO₂ at the cathode. If such ions reach the anode, they may react with hydrogen ions to produce and release gaseous CO₂. The result is net movement of CO₂ from the cathode to the anode, where it does not get reduced and is lost with oxidation products. To prevent the carbonate and bicarbonate ion produced at the cathode from reaching the anode, the anode and/or an anode buffer layer may include a cation-conducting polymer, which at least partially blocks the transport of negative ions such as bicarbonate ions to the anode.

Thus, in some designs, a bipolar membrane structure raises the pH at the cathode to facilitate CO₂ reduction while a cation-conducting polymer such as a proton-exchange layer prevents the passage of significant amounts of CO₂ and CO₂ reduction products (e.g., bicarbonate) to the anode side of the cell.

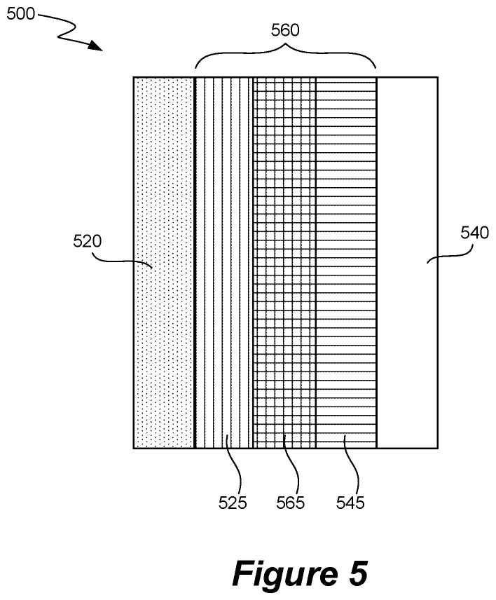

An example MEA 500 for use in COₓ reduction is shown in FIG. 5. The MEA 500 has a cathode layer 520 and an anode layer 540 separated by an ion-conducting polymer layer 560 that provides a path for ions to travel between the cathode layer 520 and the anode layer 540. In certain embodiments, the cathode layer 520 includes an anion-conducting polymer and/or the anode layer 540 includes a cation-conducting polymer. In certain embodiments, the cathode layer and/or the anode layer of the MEA are porous. The pores may facilitate gas and/or fluid transport and may increase the amount of catalyst surface area that is available for reaction.

The ion-conducting layer 560 may include two or three sublayers: a polymer electrolyte membrane (PEM) 565, an optional cathode buffer layer 525, and/or an optional anode buffer layer 545. One or more layers in the ion-conducting layer may be porous. In certain embodiments, at least one layer is nonporous so that reactants and products of the cathode cannot pass via gas and/or liquid transport to the anode and vice versa. In certain embodiments, the PEM layer 565 is nonporous. Example characteristics of anode buffer layers and cathode buffer layers are provided elsewhere herein. In certain embodiments, the ion-conducting layer includes only a single layer or two sublayers.

In some embodiments, a carbon oxide electrolyzer anode contains a blend of oxidation catalyst and an ion-conducting polymer. There are a variety of oxidation reactions that can occur at the anode depending on the reactant that is fed to the anode and the anode catalyst(s). In one arrangement, the oxidation catalyst is selected from the group consisting of metals and oxides of Ir, Pt, Ni, Ru, Pd, Au, and alloys thereof, IrRu, PtIr, Ni, NiFe, stainless steel, and combinations thereof. The oxidation catalyst can further contain conductive support particles such as carbon, boron-doped diamond, titanium, and any combination thereof.

As examples, the oxidation catalyst can be in the form of a structured mesh or can be in the form of particles. If the oxidation catalyst is in the form of particles, the particles can be supported by electronically conductive support particles. The conductive support particles can be nanoparticles. The conductive support particles may be compatible with the chemicals that are present in an electrolyzer anode when the electrolyzer is operating and are oxidatively stable so that they do not participate in any electrochemical reactions. It is especially useful if the conductive support particles are chosen with the voltage and the reactants at the anode in mind. In some arrangements, the conductive support particles are titanium, which is well-suited for high voltages. In other arrangements, the conductive support particles are carbon, which can be most useful at low voltages. In some embodiments, such conductive support particles are larger than the oxidation catalyst particles, and each conductive support particle can support one or more oxidation catalyst particles. In one arrangement, the oxidation catalyst is iridium ruthenium oxide. Examples of other materials that can be used for the oxidation catalyst include, but are not limited to, those listed above. It should be understood that many of these metal catalysts can be in the form of oxides, especially under reaction conditions.

As mentioned, in some embodiments, an anode layer of an MEA includes an ion-conducting polymer. In some cases, this polymer contains one or more covalently bound, negatively charged functional groups configured to transport mobile positively charged ions. Examples of the second ion-conducting polymer include ethanesulfonyl fluoride, 2-[1-[difluoro-[(trifluoroethenyl)oxy]methyl]-1,2,2,2-tetrafluoroethoxy]-1,1,2,2,-tetrafluoro-, with tetrafluoroethylene, tetrafluoroethylene-perfluoro-3,6-dioxa-4-methyl-7-octenesulfonic acid copolymer, other perfluorosulfonic acid polymers and blends thereof. Commercially available examples of cation-conducting polymers include e.g., Nafion 115, Nafion 117, and/or Nafion 211. Other examples of cationic conductive ionomers described above are suitable for use in anode layers.

There may be tradeoffs in choosing the amount of ion-conducting polymer in the anode. For example, an anode may include enough anode ion-conducting polymer to provide sufficient ionic conductivity, while being porous so that reactants and products can move through it easily. An anode may also be fabricated to maximize the amount of catalyst surface area that is available for reaction. In various arrangements, the ion-conducting polymer in the anode makes up about 10 and 90 wt %, or about 20 and 80 wt %, or about 25 and 70 wt % of the total anode mass. As an example, the ion-conducting polymer may make up about 5 and 20 wt % of the anode. In certain embodiments, the anode may be configured to tolerate relatively high voltages, such as voltages above about 1.2 V vs. a reversible hydrogen electrode. In some embodiments, an anode is porous in order to maximize the amount of catalyst surface area available for reaction and to facilitate gas and liquid transport.

In one example of a metal catalyst, Ir or IrOx particles (100-200 nm) and Nafion ionomer form a porous layer approximately 10 μm thick. Metal catalyst loading is approximately 0.5-3 g/cm². In some embodiments, NiFeOx is used for basic reactions.

In some embodiments, the MEA and/or the associated cathode layer is designed or configured to accommodate gas generated in situ. Such gas may be generated via various mechanisms. For example, carbon dioxide may be generated when carbonate or bicarbonate ions moving from the cathode toward the anode encounter hydrogen ions moving from the anode toward the cathode. This encounter may occur, for example, at the interface of anionic and cationic conductive ionomers in a bipolar MEA. Alternatively, or in addition, such contact may occur at the interface of a cathode layer and a polymer electrolyte membrane. For example, the polymer electrolyte membrane may contain a cationic conductive ionomer that allows transport of protons generated at the anode. The cathode layer may include an anion conductive ionomer.

Left unchecked, the generation of carbon dioxide or other gas may cause the MEA to delaminate or otherwise be damaged. It may also prevent a fraction of the reactant gas from being reduced at the anode.

The location within or adjacent to an MEA where a gas such as carbon dioxide is generated in situ may contain one or more structures designed to accommodate such gas and, optionally, prevent the gas from reaching the anode, where it would be otherwise unavailable to react.

In certain embodiments, pockets or voids are provided at a location where the gas is generated. These pockets or voids may have associated pathways that allow the generated gas to exit from the MEA, optionally to the cathode where, for example, carbon dioxide can be electrochemically reduced. In certain embodiments, an MEA includes discontinuities at an interface of anionic and cationic conductive ionomer layers such as at such interface in a bipolar MEA. In some embodiments, a cathode structure is constructed in a way that includes pores or voids that allow carbon dioxide generated at or proximate to the cathode to evacuate into the cathode.

In some embodiments, such discontinuities or void regions are prepared by fabricating in MEA in a way that separately fabricates anode and cathode structures, and then sandwiches to the two separately fabricated structures together in a way that produces the discontinuities or voids.

In some embodiments, and MEA structure is fabricated by depositing copper or other catalytic material onto a porous or fibrous matrix such as a fluorocarbon polymer and then coating the resulting structure with an anionic conductive ionomer. In some embodiments, the coated structure is then attached to the remaining MEA structure, which may include an anode and a polymer electrolyte membrane such as a cationic conductive membrane.

In some embodiments, a cathode has a porous structure and the/or an associated cathode buffer layer that has a porous structure. The pores may be present in an open cell format that allows generated carbon dioxide or other gas to find its way to the cathode.

In some MEAs, an interface between an anion conducting layer and a cation conducting layer (e.g., the interface of a cathode buffer layer and a PEM) includes a feature that resists delamination caused by carbon dioxide, water, or other material that may form at the interface. In some embodiments, the feature provides void space for the generated material to occupy until as it escapes from an MEA. In some examples, natural porosity of a layer such as an anion conducting layer provides the necessary void space. An interconnected network of pores may provide an escape route for carbon dioxide or other gas generated at the interface. In some embodiments, an MEA contains interlocking structures (physical or chemical) at the interface. In some embodiments, an MEA contains discontinuities at the interface. In some embodiments, an MEA contains of a fibrous structure in one layer adjacent the interface. A further discussion of interfacial structures between anion and cation conducting layers of MEAs is contained in Published PCT Application No. 2021/108446, published Jun. 3, 2021, and titled “MEMBRANE ELECTRODE ASSEMBLY FOR COₓ REDUCTION,” which is incorporated herein by reference in its entirety.

### Other Embodiments and Conclusion

Although omitted for conciseness, embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

What is claimed is:

1. A system for producing iron, the system comprising:
a direct reduction of iron ore (DRI) reactor configured to receive iron ore and a reducing gas, and to produce iron; and
a carbon dioxide reduction electrolyzer configured to produce carbon monoxide and/or a hydrocarbon,
wherein the system is configured to (i) transport carbon dioxide produced by the DRI reactor and/or produced by combustion of a gas generated by the DRI reactor to a cathode side of the carbon dioxide reduction electrolyzer; and/or (ii) transport at least a portion of the carbon monoxide and/or the hydrocarbon produced by the carbon dioxide reduction electrolyzer to the DRI reactor.

2. The system of claim 1, wherein the carbon dioxide reduction electrolyzer comprises an anode containing a gold catalyst and wherein, during operation, the carbon dioxide reduction electrolyzer produces the carbon monoxide.

3. The system of claim 1, further comprising a water electrolyzer configured to produce hydrogen from water, wherein the system is further configured to transport at least a portion of the hydrogen produced by the water electrolyzer to the DRI reactor, wherein the hydrogen serves as at least a part of the reducing gas.

4. The system of claim 1, further comprising a second carbon dioxide reduction electrolyzer, which second carbon dioxide reduction electrolyzer is configured to produce at least a hydrocarbon,
wherein, during operation, the carbon dioxide reduction electrolyzer produces the carbon monoxide,
wherein the system is further configured to transport at least a portion of the hydrocarbon produced by the second carbon dioxide reduction electrolyzer to the DRI reactor, and
wherein the hydrocarbon serves as a source of carbon incorporated in the iron produced by the DRI reactor.

5. The system of claim 4, wherein the second carbon dioxide electrolyzer comprises an anode containing a transition metal catalyst.

6. The system of claim 4, wherein the DRI reactor is configured to produce the iron having a carbon concentration of at least about 2% carbon by weight.

7. The system of claim 4, wherein the hydrocarbon comprises methane and/or ethene.

8. The system of claim 4, further comprising a water electrolyzer configured to produce hydrogen from water, wherein the system is further configured to transport at least a portion of the hydrogen produced by the carbon dioxide reduction electrolyzer to the DRI reactor, wherein the hydrogen serves as at least a part of the reducing gas.

9. The system of claim 1, wherein the DRI reactor is further configured to generate a top gas fuel, and wherein the system is further configured to combust the top gas fuel and provide carbon dioxide produced by combustion of the top gas fuel to the cathode side of the carbon dioxide reduction electrolyzer.

10. The system of claim 1, wherein the system is configured receive external carbon dioxide from a source external to the system and provide said external carbon dioxide to the cathode side of the carbon dioxide reduction electrolyzer.

11. The system of claim 1, wherein the system is configured to (i) transport the carbon dioxide produced by the DRI reactor and/or produced by the combustion of a gas generated by the DRI reactor to the cathode side of the carbon dioxide reduction electrolyzer; and (ii) transport at least a portion of the carbon monoxide and/or the hydrocarbon produced by the carbon dioxide reduction electrolyzer to the DRI reactor.

12. The system of claim 1, further comprising a hydrocarbon reformer configured to produce at least a portion of the reducing gas from an external source of hydrocarbon and the carbon dioxide produced by the DRI reactor and/or produced by combustion of a gas generated by the DRI reactor.

13. The system of claim 1, wherein the system does not include a hydrocarbon reformer.

14. The system of claim 1, further comprising one or more post processing units configured to physically and/or chemically modify the iron produced by the DRI reactor, and wherein the system is configured to transport carbon dioxide produced by the one or more post processing units to the cathode side of the carbon dioxide reduction electrolyzer.

15. A method comprising
(a) providing iron ore and a reducing gas to a direct reduction of iron ore (DRI) reactor configured to receive the iron ore and the reducing gas, and produce iron;
(b) electrochemically reducing, by a carbon dioxide reduction electrolyzer, carbon dioxide to produce carbon monoxide and/or a hydrocarbon; and
(c) transporting at least a portion of the carbon monoxide and/or the hydrocarbon produced by the carbon dioxide reduction electrolyzer to the DRI reactor, and/or transporting the carbon dioxide, which is produced by the DRI reactor and/or produced by combustion of a gas generated by the DRI reactor, to a cathode side of the carbon dioxide reduction electrolyzer.

16. The method of claim 15, wherein the carbon dioxide reduction electrolyzer comprises an anode containing a gold catalyst.

17. The method of claim 15, further comprising:
electrochemically reducing water, by a water electrolyzer, to produce hydrogen from the water; and
transporting at least a portion of the hydrogen produced by the water electrolyzer to the DRI reactor, wherein the hydrogen serves as at least a part of the reducing gas.

18. The method of claim 15, further comprising:
electrochemically reducing, by a second carbon dioxide reduction electrolyzer, at least a portion of the carbon dioxide to produce at least a hydrocarbon; and
transporting at least a portion of the hydrocarbon produced by the second carbon dioxide reduction electrolyzer to the DRI reactor, wherein the hydrocarbon serves as a source of carbon incorporated in the iron produced by the DRI reactor,
wherein the carbon dioxide reduction electrolyzer produces the carbon monoxide.

19. The method of claim 18, wherein the second carbon dioxide electrolyzer comprises an anode containing a transition metal catalyst.

20. The method of claim 18, wherein the DRI reactor produces the iron with a carbon concentration of at least about 1.5% carbon by weight.

21. The method of claim 18, wherein the hydrocarbon comprises methane and/or ethene.

22. The method of claim 18, further comprising:
producing hydrogen from water at a water electrolyzer; and
transporting at least a portion of the hydrogen produced by the carbon dioxide reduction electrolyzer to the DRI reactor, wherein the hydrogen serves as at least a part of the reducing gas.

23. The method of claim 15, further comprising:
generating a top gas fuel at the DRI reactor;
combusting the top gas fuel; and
providing carbon dioxide produced by combustion of the top gas fuel to the cathode side of the carbon dioxide reduction electrolyzer.

24. The method of claim 15, further comprising:
receiving external carbon dioxide from a source external to the system; and
providing said external carbon dioxide to the cathode side of the carbon dioxide reduction electrolyzer.

25. The method of claim 15, wherein (c) comprises transporting at least a portion of the carbon monoxide and/or the hydrocarbon produced by the carbon dioxide reduction electrolyzer to the DRI reactor, and transporting the carbon dioxide, which is produced by the DRI reactor and/or produced by combustion of a gas generated by the DRI reactor, to the cathode side of the carbon dioxide reduction electrolyzer.

26. The method of claim 15, further comprising reforming hydrocarbon from an external source with the carbon dioxide produced by the DRI reactor and/or produced by combustion of a gas generated by the DRI reactor to produce at least a portion of the reducing gas.

27. The method of claim 15, wherein the method does not include reforming a hydrocarbon.

28. The method of claim 15, further comprising physically and/or chemically modifying the iron produced by the DRI reactor, and transporting carbon dioxide, produced during physically and/or chemically modifying the iron, to the cathode side of the carbon dioxide reduction electrolyzer.

29. A system comprising:
a blast furnace configured to receive iron ore, coke, and to produce iron; and
a carbon dioxide reduction electrolyzer configured to produce carbon monoxide and/or a hydrocarbon,
wherein the system is configured to (i) transport carbon dioxide produced by the blast furnace and/or produced by combustion of a gas generated by the blast furnace to a cathode side of the carbon dioxide reduction electrolyzer; and/or (ii) transport at least a portion of the carbon monoxide and/or the hydrocarbon produced by the carbon dioxide reduction electrolyzer to the blast furnace.

30. The system of claim 29, further comprising a coke oven configured to produce the coke and a coke oven gas, and wherein the system is configured to transport at least carbon dioxide from the coke oven gas to carbon dioxide reduction electrolyzer.

31. The system of claim 29, wherein the blast furnace is configured to produce blast furnace gas, and wherein the system is configured to transport at least carbon dioxide from the blast furnace gas to carbon dioxide reduction electrolyzer.

32. The system of claim 29, wherein the system is configured to both (i) transport carbon dioxide produced by the blast furnace and/or produced by combustion of the gas generated by the blast furnace to the cathode side of the carbon dioxide reduction electrolyzer; and (ii) transport at least the portion of the carbon monoxide and/or the hydrocarbon produced by the carbon dioxide reduction electrolyzer to the blast furnace.

33. A method comprising:
(a) providing iron ore, coke, and a reducing gas to a blast furnace, which produces iron from the iron ore, the coke, and the reducing gas;
(b) electrochemically reducing, by a carbon dioxide reduction electrolyzer, carbon dioxide to produce carbon monoxide and/or a hydrocarbon; and
(c) transporting at least a portion of the carbon monoxide and/or the hydrocarbon produced by the carbon dioxide reduction electrolyzer to the blast furnace, and/or transporting the carbon dioxide, which is produced by the blast furnace and/or produced by combustion of a gas generated by the DRI reactor, to a cathode side of the carbon dioxide reduction electrolyzer.

34. The method of claim 33, further comprising:
producing the coke and a coke oven gas from a coke oven; and
transporting at least carbon dioxide from the coke oven gas to carbon dioxide reduction electrolyzer.

35. The method of claim 33, further comprising:
producing blast furnace gas from the blast furnace; and
transporting at least carbon dioxide from the blast furnace gas to carbon dioxide reduction electrolyzer.

36. The method of claim 33, wherein (c) comprises transporting at least a portion of the carbon monoxide and/or the hydrocarbon produced by the carbon dioxide reduction electrolyzer to the blast furnace, and transporting the carbon dioxide, which is produced by the blast furnace and/or produced by combustion of a gas generated by the blast furnace, to the cathode side of the carbon dioxide reduction electrolyzer.
